(19) United States
(12) Patent Application Publication
(10) Pub. No.: US 2004/0128183 A1
(43) Pub. Date: Jul. 1, 2004

(54) Methods and apparatus for facilitating creation and use of a survey

(76) Inventors: Darren W. Challey, Milford, CT (US); Denise Klajman Burns, Westport, CT (US); Toby Wilmott, Stamford, CT (US); Shawn W. Stelter, Hopewell Junction, NY (US)

Correspondence Address: Buckley, Maschoff, Talwalkar & Allison LLC, Five Elm Street, New Canaan, CT, 06840, US

(21) Appl. No.: 10/334,116

(22) Filed: Dec. 30, 2002

(51) Int. Cl. G06F 17/60

(52) U.S. Cl. 705/10

(57) ABSTRACT

A system, method, apparatus, means, and computer program code that allow a user or application to create a survey and/or survey template that may be provided to one or more recipients or other invitees. According to some embodiments of the present invention, a person or software application desiring to create a survey can access a survey application (and/or the device on which the application is operating) to create a survey. The survey application may have access to data created or maintained by one or more other applications or systems such as, for example, information regarding people (e.g., names, contact information, roles) who might be invited to take, preview, approve, or otherwise access the survey and/or results of the survey. In some embodiments, other people, applications, or systems may have access to some or all of the results of the-survey. Also, in some embodiments, the survey application may store surveys and results from the surveys in a single table or other central location to facilitate and control access to and security of the surveys and results.

### FIELD OF THE INVENTION

The present invention relates to a method and apparatus for creation and use of a survey

### BACKGROUND OF THE INVENTION

Circumstances may exist in which a company or individual may want to create a survey to gather information from one or more people invited to take the survey. For example, an executive of a company may want to survey its sales force for ideas on how to better market the company's products and services. As another example, a manager in the company may want to survey his or her staff to determine expected budget needs for the upcoming year. As a third example, a coordinator may want people to know about an upcoming event and request RSVPs and other thoughts regarding the event.

It would be advantageous to provide a method and apparatus that enabled a person or application to create and/or use a survey.

### SUMMARY OF THE INVENTION

Embodiments of the present invention provide a system, method, apparatus, means, and computer program code for facilitating creation and use of a survey. According to some embodiments of the present invention, a person or software application desiring to create a survey can access a survey application (and/or the device on which the application is operating) to create a survey. In some embodiments, the survey application may have access to data created or maintained by one or more other applications or systems such as, for example, information regarding people (e.g., names, contact information, roles) who might be invited to take, preview, approve, or otherwise access the survey and/or results of the survey. More specifically, another application may develop and maintain data regarding people (e.g., names, assigned roles, email addresses or other contact information) employed by a company. The application may allow access to or retrieval of the data by the survey application such that a survey creator can select or indicate one or more people in the company to receive invitations to take a survey. In this manner, neither the survey creator nor the survey application needs to maintain the information regarding potential invitees for the survey, but can retrieve such information when needed. In addition, in some embodiments, other people, applications, or systems may have access to some or all of the results of the survey. Also, the survey application may store surveys and results from the surveys in a single table or other central location to facilitate and control access to and security of the surveys and results.

When creating a survey, a person or application may designate one or more invitees for the survey, either individually or by group. In addition, in some embodiments, the person or application may designate one or more approvers individually or by group that need to consent or at least review the survey prior to invitations to take the survey being sent to the invitees. A survey may be deployed in various ways, such as on a Web site, intranet resource, etc.

An invitation to take a survey may include a link or other identifier or information regarding the location of the survey, as opposed to the survey itself. An invitee may then use the link or other identifier or information to access the survey (e.g., access a Web site or other electronic resource where the survey is located). Should one or more of the invitees fail to access the survey or otherwise respond to an invitation to take the survey, a reminder can be sent to the invitee(s) regarding the survey, a deadline to complete the survey, etc. Responses to a survey may be maintained anonymously or associated with the specific survey takers. In some cases, an invitee may be able to indicate that the invitee has chosen not to respond to an invitation or not to take a survey.

In some embodiments, information regarding potential survey creators, survey invitees, takers or respondents, people or applications that may access or receive survey results, etc. may be stored in one or more devices or a centralized system or location. For example, multiple surveys and/or the results of one or more surveys may be stored in a single table.

In some embodiments, a survey taker's response to one or more questions in a survey may trigger a message sent to one or more designated parties or email addresses. For example, if a customer answers a company's survey indicating that the customer is unhappy with the company's customer service or products, an email message may be sent automatically to the company's head of customer service and to the salesperson assigned to the customer.

Additional objects, advantages, and novel features of the invention shall be set forth in part in the description that follows, and in part will become apparent to those skilled in the art upon examination of the following or may be learned by the practice of the invention.

According to some embodiments of the present invention, a method for facilitating use of a survey may include facilitating creation of a survey, wherein the survey has an associated invitee and an associated approver; providing data indicative of a request to the approver to review the survey; providing an invitation to the invitee to take the survey, the invitation including data indicative of a location of the survey; and allowing access by the invitee to the survey at the location. In some other embodiments, a method for facilitating use of a survey may include facilitating creation of a first survey, the first survey having an associated first invitee; facilitating creation of a second survey, the second survey having an associated second invitee; providing an invitation to the first invitee to take the first survey, the invitation including data indicative of a location associated with the first survey; allowing access by the first invitee to the first survey; providing an invitation to the second invitee to take the second survey, the invitation including data indicative of a location associated with the second survey; allowing access by the second invitee to the second survey; and storing results of the first survey and the second survey in a central location. In some additional embodiments, a method for facilitating use of a survey may include allowing access to a central resource by a user; facilitating creation of a survey by the user via the central resource; receiving from the user data indicative of an invitee associated with the survey; receiving from the user data indicative of an approver associated with the survey; allowing the approver to access the survey; providing an invitation to the desired invitee to take the survey, the invitation including data indicative of a location of the survey; and allowing access by the desired invitee to the survey. In some further embodiments, a method for facilitating use of a survey may include facilitating creation of a survey by a user; receiving or retrieving data from an application or database, the data being indicative of a desired invitee of the survey; providing an invitation to take the survey to the desired invitee; and facilitating access to the survey by the desired invitee. In some other embodiments, a method for facilitating use of a survey may include facilitating creation of a survey by a user; providing data indicative of the survey to a first application, wherein the first application provides an invitation to take the survey to a desired invitee; and facilitating access to the survey by the desired invitee. In some additional embodiments, a method for facilitating use of a survey may include facilitating creation of a template for a survey, wherein the survey includes at least one question; receiving information usable with the at least one question in the survey; generating the survey using the template and the information; and allowing access by a designated invitee to the survey. In some other embodiments, a method for facilitating use of a survey may include facilitating creation of a survey; receiving data indicative of an invitee associated with the survey; retrieving data indicative of contact information for the invitee; providing, using the contract information, an invitation to take the survey to the invitee; and facilitating access to the survey by the invitee. In some other embodiments, a method for facilitating use of a survey may include facilitating creation of a survey; providing data indicative of a group of at least one potential invitee for the survey; receiving data indicative of a selection of an invitee from the group; retrieving data indicative of contact information for the invitee; providing, using the contact information, an invitation to take the survey to the invitee; and facilitating access to the survey by the invitee.

According to some embodiments of the present invention, a system for facilitating use of a survey may include a memory; a communication port; and a processor connected to the memory and the communication port, the processor being operative to facilitate creation of a survey, wherein the survey has an associated invitee and an associated approver; provide data indicative of a request to the approver to review the survey; provide an invitation to the invitee to take the survey, the invitation including data indicative of a location of the survey; and allow access by the invitee to the survey at the location. In some other embodiments, a system for facilitating use of a survey may include a memory; a communication port; and a processor connected to the memory and the communication port, the processor being operative to facilitate creation of a first survey, the first survey having an associated first invitee; facilitate creation of a second survey, the second survey having an associated second invitee; provide an invitation to the first invitee to take the first survey, the invitation including data indicative of a location associated with the first survey; allow access by the first invitee to the first survey; provide an invitation to the second invitee to take the second survey, the invitation including data indicative of a location associated with the second survey; allowing access by the second invitee to the second survey; and store results of the first survey and the second survey in a central location. In some additional embodiments, a system for facilitating use of a survey may include a memory; a communication port; and a processor connected to the memory and the communication port, the processor being operative to allow access to a central resource by a user; facilitate creation of a survey by the user via the central resource; receive from the user data indicative of an invitee associated with the survey; receive from the user data indicative of an approver associated with the survey; allow the approver to access the survey; provide an invitation to the desired invitee to take the survey, the invitation including data indicative of a location of the survey; and allow access by the desired invitee to the survey. In some further embodiments, a system for facilitating use of a survey may include a memory; a communication port; and a processor connected to the memory and the communication port, the processor being operative to facilitate creation of a survey by a user; receive or retrieve data from an application or database, the data being indicative of a desired invitee of the survey; provide an invitation to take the survey to the desired invitee; and facilitate access to the survey by the desired invitee. In some other embodiments, a system for facilitating use of a survey may include a memory; a communication port; and a processor connected to the memory and the communication port, the processor being operative to facilitate creation of a survey by a user; provide data indicative of the survey to a first application, wherein the first application provides an invitation to take the survey to a desired invitee; and facilitate access to the survey by the desired invitee. In some additional embodiments, a system for facilitating use of a survey may include a memory; a communication port; and a processor connected to the memory and the communication port, the processor being operative to facilitate creation of a template for a survey, wherein the survey includes at least one question; receive information usable with the at least one question in the survey; generate the survey using the template and the information; and allow access by a designated invitee to the survey. In some other embodiments, a system for facilitating use of a survey may include a memory; a communication port; and a processor connected to the memory and the communication port, the processor being operative to facilitate creation of a survey; receive data indicative of an invitee associated with the survey; retrieve data indicative of contact information for the invitee; provide, using the contract information, an invitation to take the survey to the invitee; and facilitate access to the survey by the invitee. In some other embodiments, a system for facilitating use of a survey may include a memory; a communication port; and a processor connected to the memory and the communication port, the processor being operative to facilitate creation of a survey; provide data indicative of a group of at least one potential invitee for the survey; receive data indicative of a selection of an invitee from the group; retrieve data indicative of contact information for the invitee; provide, using the contact information, an invitation to take the survey to the invitee; and facilitate access to the survey by the invitee.

According to some embodiments of the present invention, a computer program product in a computer readable medium for facilitating use of a survey may include first instructions for creating a survey, wherein the survey has an associated invitee and an associated approver; second instructions for sending data indicative of a request to the approver to review the survey; third instructions for sending an invitation to the invitee to take the survey, the invitation including data indicative of a location of the survey; and fourth instructions for providing the survey to the invitee. In some other embodiments, a computer program product in a computer readable medium for facilitating use of a survey may include first instructions for creating a first survey, the first survey having an associated first invitee; second instructions for creating a second survey, the second survey having an associated second invitee; third instructions for sending an invitation to the first invitee to take the first survey, the invitation including data indicative of a location associated with the first survey; fourth instructions for providing access by the first invitee to the first survey; fifth instructions for sending an invitation to the second invitee to take the second survey, the invitation including data indicative of a location associated with the second survey; sixth instructions for providing access by the second invitee to the second survey; and seventh instructions for keeping results of the first survey and the second survey in a central location. In some other embodiments, a computer program product in a computer readable medium for facilitating use of a survey may include first instructions for providing access to a central resource by a user; second instructions for creating a survey by the user via the central resource; third instructions obtaining from the user data indicative of an invitee associated with the survey; fourth instructions for obtaining from the user data indicative of an approver associated with the survey; fifth instructions for providing the approver to access the survey; sixth instructions for sending an invitation to the desired invitee to take the survey, the invitation including data indicative of a location of the survey; and seventh instructions for providing access by the desired invitee to the survey. In some other embodiments, a computer program product in a computer readable medium for facilitating use of a survey may include first instructions for creating a survey by a user; second instructions for obtaining data from an application or database, the data being indicative of a desired invitee of the survey; third instructions for sending an invitation to take the survey to the desired invitee; and fourth instructions for providing access to the survey by the desired invitee. In some other embodiments, a computer program product in a computer readable medium for facilitating use of a survey may include first instructions for creating a survey by a user; second instructions for sending data indicative of the survey to a first application, wherein the first application provides an invitation to take the survey to a desired invitee; and third instructions for providing access to the survey by the desired invitee. In some other embodiments, a computer program product in a computer readable medium for facilitating use of a survey may include first instructions for creating a template for a survey, wherein the survey includes at least one question; second instructions for obtaining information usable with the at least one question in the survey; third instructions for creating the survey using the template and the information; and fourth instructions for providing access by a designated invitee to the survey.

In some other embodiments, a computer program product in a computer readable medium for facilitating use of a survey may include first instructions for creating a survey; second instructions for obtaining data indicative of an invitee associated with the survey; third instructions for obtaining data indicative of contact information for the invitee; fourth instructions for sending, using the contract information, an invitation to take the survey to the invitee; and fifth instructions for providing access to the survey by the invitee. In some other embodiments, a computer program product in a computer readable medium for facilitating use of a survey may include first instructions for creating a survey; second instructions for sending data indicative of a group of at least one potential invitee for the survey; third instructions for obtaining data indicative of a selection of an invitee from the group; fourth instructions for obtaining data indicative of contact information for the invitee; fifth instructions for sending, using the contact information, an invitation to take the survey to the invitee; and sixth instructions for providing access to the survey by the invitee.

According to some embodiments of the present invention, an apparatus for facilitating use of a survey may include means for creating a survey, wherein the survey has an associated invitee and an associated approver; means for sending data indicative of a request to the approver to review the survey; means for sending an invitation to the invitee to take the survey, the invitation including data indicative of a location of the survey; and means for providing the survey to the invitee. In some other embodiments, an apparatus for facilitating use of a survey may include means for creating a first survey, the first survey having an associated first invitee; means for creating a second survey, the second survey having an associated second invitee; means for sending an invitation to the first invitee to take the first survey, the invitation including data indicative of a location associated with the first survey; means for providing access by the first invitee to the first survey; means for sending an invitation to the second invitee to take the second survey, the invitation including data indicative of a location associated with the second survey; means for providing access by the second invitee to the second survey; and means for keeping results of the first survey and the second survey in a central location. In some other embodiments, an apparatus for facilitating use of a survey may include means for providing access to a central resource by a user; means for creating a survey by the user via the central resource; means obtaining from the user data indicative of an invitee associated with the survey; means for obtaining from the user data indicative of an approver associated with the survey; means for providing the approver to access the survey; means for sending an invitation to the desired invitee to take the survey, the invitation including data indicative of a location of the survey; and means for providing access by the desired invitee to the survey. In some other embodiments, an apparatus for facilitating use of a survey may include means for creating a survey by a user; means for obtaining data from an application or database, the data being indicative of a desired invitee of the survey; means for sending an invitation to take the survey to the desired invitee; and means for providing access to the survey by the desired invitee. In some other embodiments, an apparatus for facilitating use of a survey may include means for creating a survey by a user; means for sending data indicative of the survey to a first application, wherein the first application provides an invitation to take the survey to a desired invitee; and means for providing access to the survey by the desired invitee. In some other embodiments, an apparatus for facilitating use of a survey may include means for creating a template for a survey, wherein the survey includes at least one question; means for obtaining information usable with the at least one question in the survey; means for creating the survey using the template and the information; and means for providing access by a designated invitee to the survey. In some other embodiments, an apparatus for facilitating use of a survey may include means for creating a survey; means for obtaining data indicative of an invitee associated with the survey; means for obtaining data indicative of contact information for the invitee; means for sending, using the contract information, an invitation to take the survey to the invitee; and means for providing access to the survey by the invitee. In some other embodiments, an apparatus for facilitating use of a survey may include means for creating a survey; means for sending data indicative of a group of at least one potential invitee for the survey; means for obtaining data indicative of a selection of an invitee from the group; means for obtaining data indicative of contact information for the invitee; means for sending, using the contact information, an invitation to take the survey to the invitee; and means for providing access to the survey by the invitee.

According to some embodiments of the present invention, a system may include a first device or application adapted to facilitate creation of a survey by a user, wherein the first device or application receives or retrieves data indicative of an invitee of the survey; a second device or application adapted to create and/or store information regarding contact information for at least one potential invitee for the survey; wherein the first device or application is adapted to retrieve contact information for the invitee created or stored by the second device or application and to provide an invitation to the invitee to take the survey.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components for an embodiment of an apparatus usable with the methods of the present invention;

FIG. 2 is another block diagram of system components for an embodiment of an apparatus usable with the methods of the present invention;

FIG. 3 is a flowchart of a first embodiment of a method in accordance with the present invention;

FIGS. 4-8 are illustrations of content displayed on a computer monitor that may enable a user to create a survey in according with some embodiments of the present invention;

FIGS. 9-10 are illustrations of content displayed on a computer monitor that may allow a user to indicate or select one or more invitees for a survey in some embodiments of the present invention;

FIGS. 11-12 are illustrations of content displayed on a computer monitor that may allow a user to indicate or select one or more approvers for a survey in some embodiments of the present invention;

FIG. 13 is an illustration of a representative survey created with the method of FIG. 3;

FIG. 14 is a flowchart of a second embodiment of a method in accordance with the present invention;

FIG. 15 is a flowchart of a third embodiment of a method in accordance with the present invention;

FIG. 16 is a flowchart of a fourth embodiment of a method in accordance with the present invention;

FIG. 17 is a flowchart of a fifth embodiment of a method in accordance with the present invention;

FIG. 18 is an illustration of a representative window that may be created in some embodiments of the present invention;

FIG. 19 is another illustration of a representative window that may be created in some embodiments of the present invention;

FIG. 20 is another illustration of a representative window that may be created in some embodiments of the present invention;

FIG. 21 is an illustration of another representative window that may be created in some embodiments of the present invention;

FIG. 22 is another illustration of a representative window that may be created in some embodiments of the present invention;

FIG. 23 is an illustration of another representative window that may be created in some embodiments of the present invention;

FIG. 24 is an illustration of another representative window that may be created in some embodiments of the present invention;

FIG. 25 is a block diagram of components for an embodiment of the server of FIGS. 1 and 2;

FIG. 26 is an illustration of a representative survey information database of FIG. 25;

FIG. 27 is an illustration of a representative response information database of FIG. 25; and

FIG. 28 is an illustration of a representative user information database of FIG. 25.

### DETAILED DESCRIPTION

Applicants have recognized that there is a market opportunity for systems, means, computer code, and methods that allow a user or application to create a survey and/or survey template that may be provided to one or more recipients or other invitees. In addition, applicants have recognized that there is a market opportunity for systems, means, computer code and methods that facilitate a user or application using one or more previously created surveys, that facilitate a user or application designating one or more approvers for a survey, that facilitate a user or application indicating one or more recipients or invitees for a survey, and that facilitate the centralization of data and other information regarding a survey, potential invitees, etc. These and other features will be discussed in further detail below, by describing a system, individual devices, and processes according to embodiments of the invention.

System

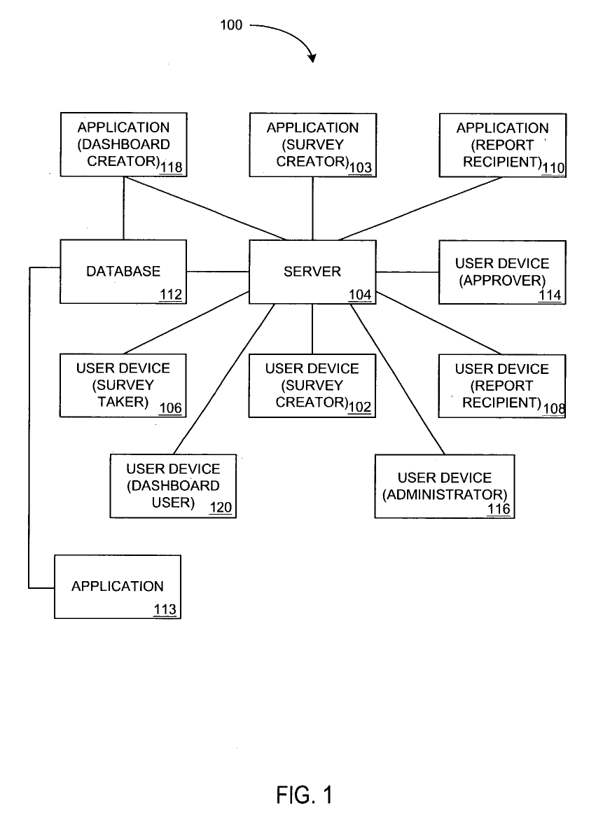

Now referring to FIG. 1, an apparatus or system 100 usable with the methods disclosed herein is illustrated. In some embodiments, the apparatus 100 may include at least one user device 102 or an application creator device 103 in communication with a server 104 that facilitates creation of a survey by a user or application. In addition, in some embodiments the system 100 may include a user device 106 that may enable a user to access and take a survey and/or a user device 108 that may enable a user to receive or access the results of a survey or a report created from the results of a survey. In some embodiments, an application 110 may be able to receive or access the results of a survey or a report created from the results of a survey. The application 110 may use survey result data to perform other calculations or functions. In some embodiments, the user devices 102, 106, 108 may not need any special software other than standard operating system and browser software installed or operating on them in order to access, create, view, or review a survey, as a person using one of the user devices 102, 106, 108 may access Web sites, a survey application (which may be operating on the server 104), the server 104, or other electronic resources or devices that can provide access to the survey or can facilitate creation of the survey. Thus, no special client side software is necessary for implementation of the invention. By providing access via a conventional browser on a user device to a survey creation application via a Web site, intranet site, or other electronic resource operated by or on the server 104, the user device used by a survey taker may not need to have any special software, cookies, plug-ins, etc. installed on it and all data and software needed to created the survey can be operated or accessed by the server 104.

The server 104 may provide the results or report, store, or maintain the results or report in a database 112 or single database table, or otherwise facilitate access to the results or report by a user or application. In some embodiments, some or all of the database 112 may be available or accessible on a company wide, organization wide, enterprise wide, etc. basis. Thus, the database 112 may represent or include a data warehouse that is accessible by multiple applications, devices, etc. Other applications (e.g., application 113), devices, or systems may store or maintain information in the database 112 for use or access by the server 104. For example, in some embodiments, the survey application operating on the server 104 may have access to data created or maintained by one or more other applications (e.g., the application 113) or systems such as, for example, information regarding people (e.g., names, contact information, roles) who might be invited to take, preview, approve, or otherwise access a survey and/or results of the survey. The people may be employees of a company, customers or potential customers of the company, etc. As a more specific example, a customer relationship management application (e.g., the application 113) may create profiles of customers and store the profile data in the database 112. When a server 104 is facilitating creation of a survey, the server 104 may access or retrieve the profile data to obtain a list of potential invitees for the survey and email addresses for the potential invitees. In this manner, neither the survey creator nor the server 104 needs to maintain or develop the information regarding potential invitees for the survey. As illustrated by this example, in some embodiments, the system 100 may include other devices or applications that create or maintain data that is accessed, retrieved or used by the server 104 when the server 104 facilitates creation of a survey.

In some embodiments, the system 100 may include a user device 114 that may enable a user to access a survey for purposes of reviewing or approving the survey, and/or a user device 116 that may enable a user to act as an administrator of the system 100. In some embodiments, the user device 114 may not need any special software other than standard operating system and browser software installed or operating on it in order to access, view, or review a survey, as a person using the user device 114 may access Web sites, the server 104, a survey application (which may be operating on the server 104), or other electronic resources or devices that can provide access to the survey. In some embodiments, the system 100 may include an application 118 that creates or provides a window, interface or dashboard for real time access to survey results. The application 118 may access or retrieve the survey results from the database 112 or a table in the database 112. A user device 120 may operate or access the window, interface or dashboard in order to enable a user to view survey results in real or near real time.

In some embodiments, the server 104 may implement or host a Web site, corporate intranet, or other electronic resource, which may be accessible via an intranet, the World Wide Web, or other communications network. In some embodiments, the server 104 can comprise a single device or computer, a mainframe or host computer, a networked set or group of devices or computers, a workstation, etc. The use, configuration and operation of the server 104 will be discussed in more detail below.

User or client devices 102, 106, 108, 114, 116, and 120 preferably allow users to interact with the server 104 and the remainder of the apparatus 100. A user device also may enable a user to access Web sites, software, databases, etc. hosted or operated by the server 104 or other devices. If desired, user devices also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

An application may operate on any type of computer, computer system or other device suitable for or applicable to operation with the apparatus 100 and the methods disclosed herein. In some embodiments, different applications may be operating on the same device or group of devices.

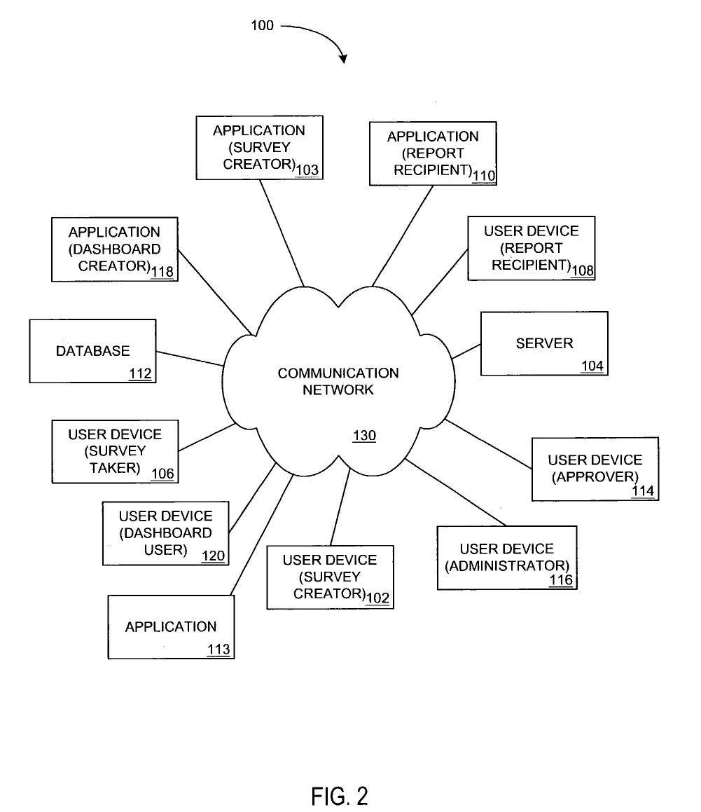

In some embodiments, one or more of the components illustrated in FIG. 1 may communicate directly or indirectly with the server 104 and/or each other via a computer, data, or other communications network, as illustrated in by a communications network 130 in FIG. 2.

In some embodiments, the communications network 130 might be or include the Internet, an intranet, the World Wide Web, or some other public or private computer, cable, telephone, client/server, peer-to-peer, or communications network or intranet. The communications network 130 illustrated in FIG. 2 is meant only to be generally representative of cable, computer, telephone, peer-to-peer or other communication networks for purposes of elaboration and explanation, but not limitation, of the present invention and other devices, networks, etc. may be connected to the communications network 130 without departing from the scope of the present invention. In some embodiments, the communications network 130 might or include public and/or private wide area networks, local area networks, wireless networks, data communication networks or connections, intranets, routers, satellite links, microwave links, cellular or telephone networks, radio links, fiber optic transmission lines, ISDN lines, Ti lines, DSL, etc. Moreover, as used herein, communications may include those enabled by wired or wireless technology.

Many different types of implementations or hardware/software configurations can be used in the system 100 and with the methods disclosed herein and the methods disclosed herein are not limited to any specific hardware/software configuration for the system 100 or any of its components. In some embodiments, different components may be located in different intranets or at different locations, be protected by different security measures, etc. For example, one or more of the devices located in FIG. 1 might be located outside of a corporate firewall from the server 104.

Process Description

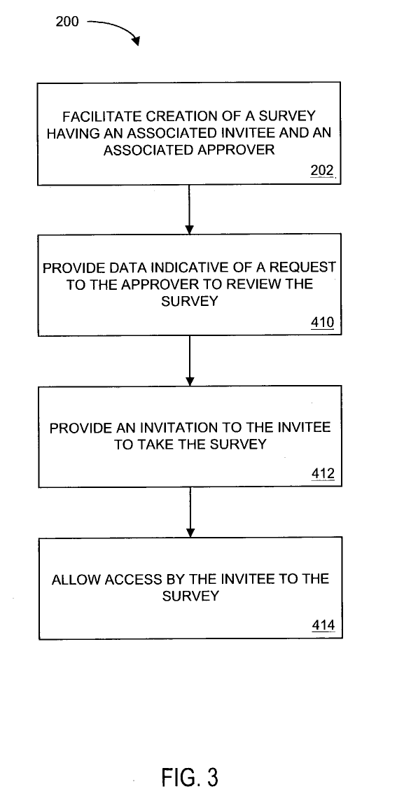

Reference is now made to FIG. 3, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. In some embodiments, some or all of the steps of the method 200 may be performed or completed by the server 104 or another device. For purposes of elaboration, but not limitation, the server 104 is assumed to be implementing the method 200. Reference to the server 104 performing the method 200 also will include a survey application or other software operating on or in conjunction with the server 104 to implement one or more steps of the method 200.

Processing begins at a step 202 during which the server 104 facilitates creation of a survey having an associated invitee and an associated approver. In some embodiments, the server 104 may operate a Web site or application that may be accessible by a user to facilitate creation of the survey during the step 202. The Web site or application may allow a user to create a survey or survey template having one or more questions. Access to or use of the Web site or application may be password protected or secured via some other means. Different types of surveys and/or questions are contemplated under the present invention and the present invention is not limited to any specific survey or question type. In different embodiments, facilitating creation of a survey may entail or include different actions, activities, determinations, etc. In some embodiments, facilitating creation of a survey may include, but does not have to include, some or all of the actions, activities, steps, determinations, variations, etc. described here. In the simplest case, facilitating creation of a survey may include receiving data or information regarding a question for the survey.

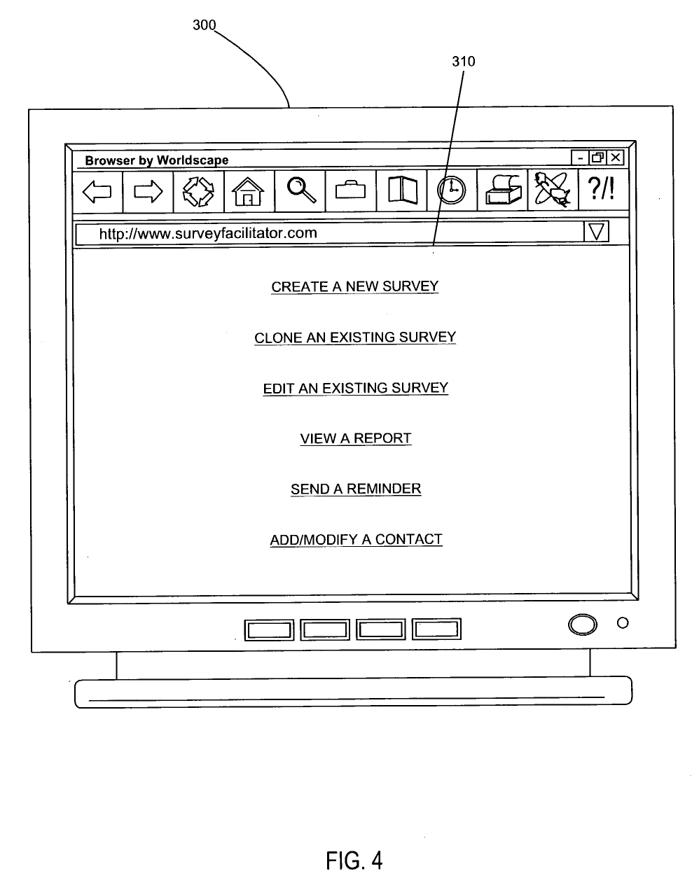

Now referring to FIGS. 4-8 a representative example is illustrated of how a survey might be generated or how survey creation might be facilitated by an application or Web site provided or operated by the server 104.

As illustrated in FIG. 4, a display 300 that might be part of the user device 102 illustrates a Web page 310 that may be included in a Web side operated by the server 104. The Web page 310 may be displayed by browser or other software operating on the user device 102. The Web page 310 may be served by the server 104 by a user using the user device 102. Thus, the user device 102 needs no special software installed or operating on it and needs only an operating system and a browser. By making the proper selection on the Web page 310, a user may be able to “CREATE A NEW SURVEY”, “CLONE AN EXISTING SURVEY”, “EDIT AN EXISTING SURVEY”, “VIEW A REPORT”, “SEND A REMINDER”, or “ADD/MODIFY A CONTACT”. In some embodiments, other or different functions or choices may be provided.

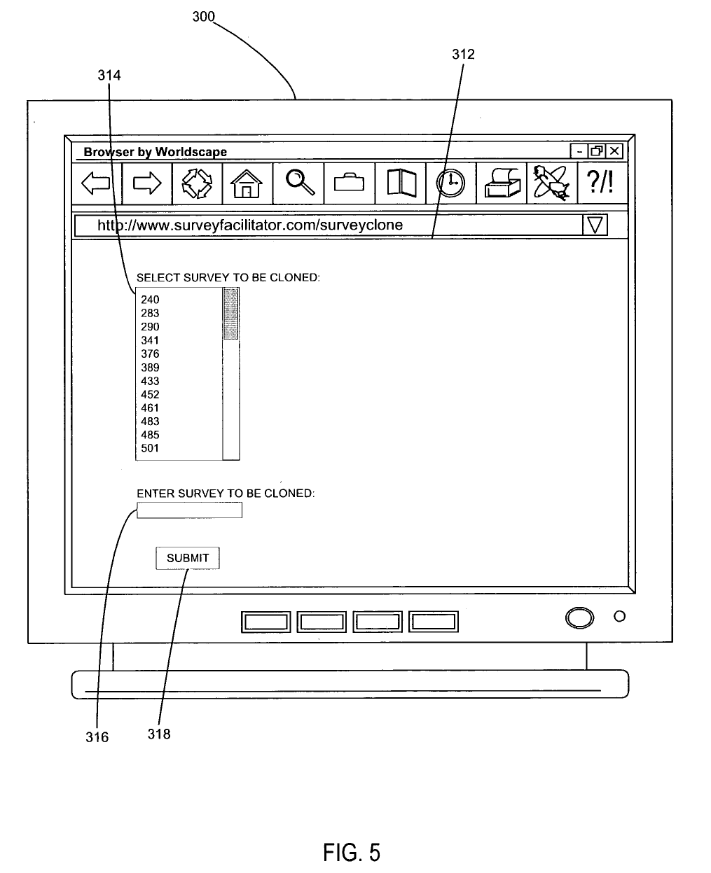

If the user selects “CLONE AN EXISTING SURVEY” on the Web page 310, a Web page 312 may be presented or displayed, as illustrated in FIG. 5. The Web page 312 may be served by the server 104 or be part of a Web site hosted by the server 104. The Web page 312 may include a text box 314 in which the user may select from an existing list of created surveys. The user can then edit or modify the survey to create a new survey. The surveys listed in the box 316 may include surveys previously created by the user, other previously created surveys to which the user has access, etc. The Web page 312 also may include a text box 316 that allows the user to type in the name or identifier of the survey to be cloned directly. After selecting or entering a survey, the user may click on or select a SUBMIT button 318 to submit the information.

In some embodiments, the block 314 or some other portion of the Web page 312 may include other information regarding the surveys listed in the block 314, such as, for example, titles of the surveys, dates of creation of the surveys, identifiers of the creators of the surveys, legal statements or disclaimers, etc.

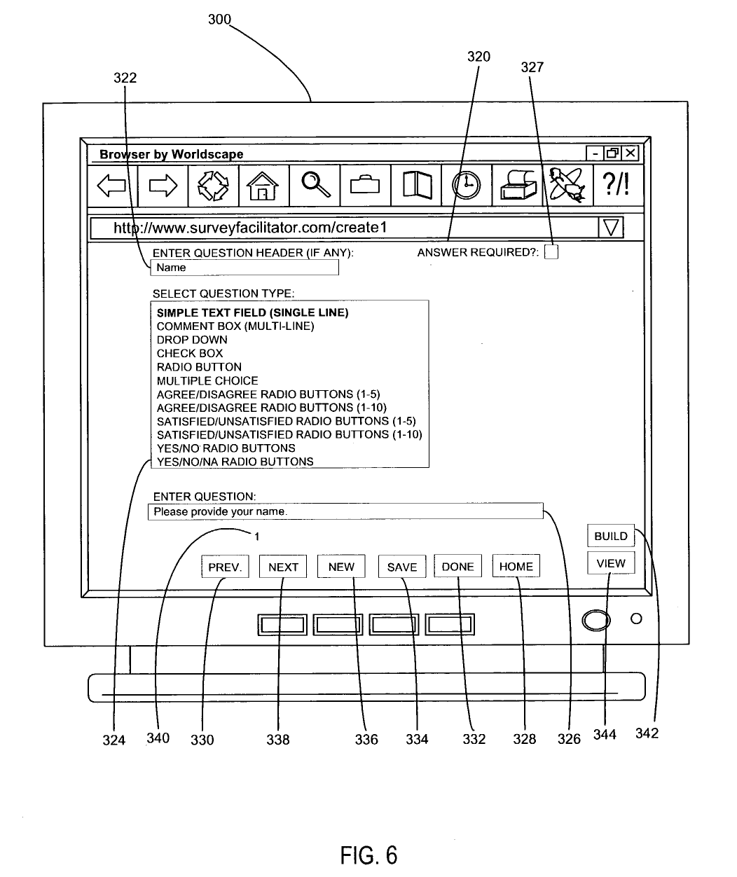

If the user selects “CREATE A NEW SURVEY” on the Web page 310, a Web page 320 may be presented, as illustrated in FIG. 6. The Web page 320 may be served by the server 104 or be part of a Web site hosted by the server 104. The Web page 320 may allow a user to enter a question header if desired in a text block 322, to select a question type in a menu block 324, and to enter a question into a text block 326. Each question type may have its own type format. As illustrated in the example in FIG. 6, the user has entered “name” in the text block 322, selected “SIMPLE TEXT FIELD (SINGLE LINE)” in the menu block 324, and entered “Please provide your name.” in the text block 326. The present invention allows for any type of question or survey request to be used and the types listed in the block 324 provide illustrative examples. In some embodiments, the Web page 320 also may allow a survey creator to add a title to the survey, an introduction to the survey, a legal disclaimer or statement for the survey, directions on how to take the survey, etc.

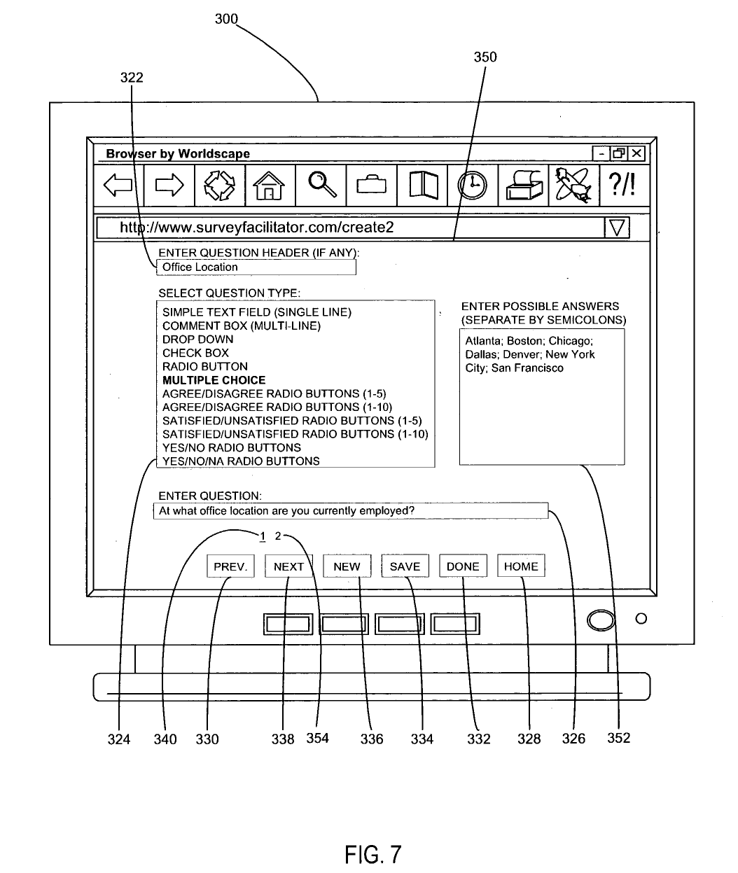

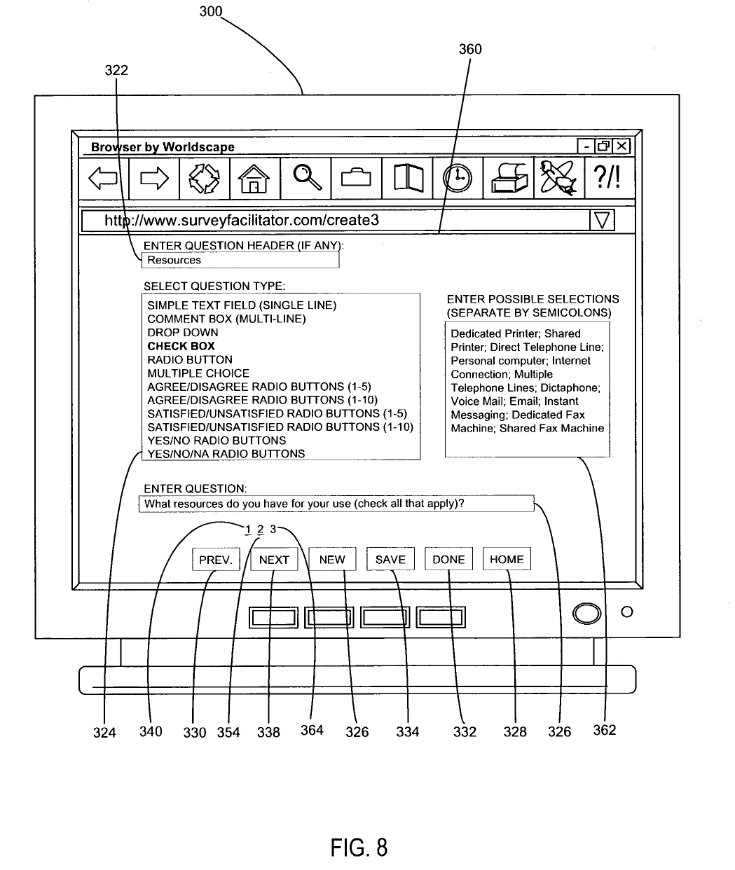

In some embodiments, a survey creator may be able to indicate if a question or request in a survey is required. That is, the survey creator may indicate whether or not a survey question or request must be responded to by a survey taker or respondent in order for the survey taker's response to the survey to be entered, considered valid, etc. For example, the window 320 may include a check box 327 that the survey creator may check if an answer to the request “Please provide your name” is required from a survey taker. If the survey taker does not answer the question or request, the survey taker may be prompted to answer the question or request when taking the survey. Alternatively, the survey taker may be warned that failure to answer the question or request will result in the survey being considered incomplete, invalid, etc. As another alternative, the survey may terminate if the survey taker fails to answer the question. In some embodiments, a survey may branch to other or different questions based on survey taker's response to one or more earlier questions. For sake of convenience and ease of explanation, the check box 327 is not shown in FIGS. 7 and 8.

In some embodiments, the Web page 320 may include other functions or options. For example, the Web page 320 may include a HOME button 328, selection of which may display the Web page 310 or another designated Web page, and a PREV. button 330, selection of which may take the user to the previously displayed Web page or the previously entered question. In addition, the Web page 320 may include a DONE button 332, selection of which may indicate that the user is done entering questions for the current survey. The Web page 320 may include a SAVE button 334, selection of which may allow the user to save the current survey or facilitate saving of the current survey, and a NEW button 336, selection of which may allow the user to create a new survey. The Web page 320 also may include a NEXT button 338, selection of which will allow the user to create another survey question or request or move to the next Web page. The Web page 320 also may include a “1” 340 to indicate that the survey generator is working with the first question in the survey.

In some embodiments, the Web page 320 may include a BUILD button 342, selection of which may cause the server 104 or server application to create the survey from the questions/requests generated by the survey creator. In addition, the Web page 320 also may include a VIEW button 344, selection of which may cause the server 104 or the survey application to display a view of the survey as created so far. For example, selecting the BUILD button 342 may cause an HTML (HyperText Markup Language) version of the survey to be generated. Selecting the VIEW button 344 may cause the HTML coded page to be displayed to the survey creator. Thus, a preview of the survey can be created. The preview of the survey may use a consistent URL (Uniform Resource Locator) such that changes can be made to the survey and reflected in the preview version of the survey. Other people may be able to access and view the preview version of the survey. For sake of convenience and ease of explanation, the buttons 342 and 344 are not shown in FIGS. 7 and 8.

In some embodiments, a survey creator may be able to indicate if an answer to a question should be validated by the server 104 prior to be accepted by the server 104. For example, if a question asked a survey taker to provide his or her social security number, the server 104 may check to see if the survey taker's answer comprised nine numerals. When the survey creator created the question, the server 104 may provide a “VALIDATE ANSWER” check box where the survey creator can indicate if the server 104 should validate an answer provided to the question. Checking the box may lead the survey creator to another Web page or window where the survey creator can indicate how the answer should be validated.

Once the user has entered or selected the information on the Web page 320, the user may select or click on the NEXT button 338 to be presented with another Web page or a blank copy of the Web page 320 that may allow the user to enter another question or request, as illustrated in FIG. 7. Web page 350 illustrates another question or request entered by the user. As illustrated in the example in FIG. 7, the user has entered “Office Location” in the text block 322, selected MULTIPLE CHOICE in the menu block 324, and entered “At what office location are you currently employed” in the text block 326. Since the user selected MULTIPLE CHOICE in the block 324, the Web page 350 may display a text block 352 that allows the user to enter potential answers/responses to the question/request entered into the text block 326. In this example, the user has entered the possible answers of “Atlanta”, “Boston”, “Chicago”, “Dallas”, “Denver”, “New York City”, and “San Francisco” as possible answers to the question “At what office location are your currently employed?” presented in text block 326. The Web page 350 also may include the “1” 340 and a “2” 354 to indicate that the survey generator is working with the second question in the survey. Selecting on or clicking the “1” 340 may cause the Web page 320 to be displayed. Once the second question is created, the Web page 320 may display the “2” 354 that causes the Web page 350 to be redisplayed when selected. The Web page 350 may be served by the server 104 or be part of a Web site hosted by the server 104.

Once the user has entered or selected the information on the Web page 350, the user may select or click on the NEXT button 338 to be presented with another Web page or a blank copy of the Web page 320, 350 that may allow the user to enter another question or request, as illustrated in FIG. 8. Web page 360 illustrates another question or request entered by the user. As illustrated in the example in FIG. 8, the user has entered “Resources” in the text block 322, selected CHECK BOX in the menu block 324, and entered “What resources do you have for your use (check all that apply)?” in the text block 326. Since the user selected CHECK BOX in the block 324, the Web page 360 may display a text block 362 that allows the user to enter potential answers/responses to the question/request entered into the text block 326. In this example, the user has entered the possible answers of “Dedicated Printer”, “Shared Printer”, “Direct Telephone Line”, “Personal Computer”; “Internet Connection”, “Multiple Telephone Lines”, “Dictaphone”, “Voice Mail”, “Instant Messaging”, “Dedicated Fax Machine”, and “Shared Fax Machine” as possible answers to the question “What resources do you have for your use (check all that apply)?” presented in text block 326.

The Web page 356 also may include the “1” 340, the “2” 354, and a “3” 364 to indicate that the survey generator is working with the third question in the survey. Selecting on or clicking the “1” 340 may cause the Web page 320 to be displayed and clicking on or selecting the “2” 354, may cause the Web page 350 to be displayed. Once the third question is created, the Web page 320 and the Web page 350 may display the “3” 354 that causes the Web page 360 to be redisplayed when selected. The Web page 360 may be served by the server 104 or be part of a Web site hosted by the server 104.

While the current survey illustrated in FIGS. 4-8 provides only three questions/requests, other surveys may have any number of questions or requests. The present invention is not limited to how the survey questions are generated or created or the format or content of the survey generation process as illustrated in FIGS. 4-8. The server 104 may store questions or requests, responses or answers, and other survey related information in a data (e.g., the database 112). Web pages may display the number of questions previously created, the total number of questions for a survey, selectable links to one or more previously created questions, etc.

As previously discussed above, in some embodiments a user may access an application or Web site operated or provided by the server 104 in order to create the survey. The user may be accessing the server 104 or the application or Web site by using a user device. Alternatively, the software application 103 operating on a computer or other device may access the server 104 or the application or Web site to create the survey. So long as the application 103 knows, can retrieve, or is programmed with the appropriate hooks, programming interfaces, parameters or other protocols for the application or Web site operating on the server 104, the application 103 can create the survey.

In some embodiments, a survey creator may be able to indicate whether or not a specific response to a designated question should trigger an immediate message, survey termination, or alert of some type. For example, the Web page 360 may include a check box that the survey creator may check to indicate that an email notification is to be sent to the survey creator or another designated party if a survey taker answering the request “What resources do you have for your use (check all that apply)?” selects “Dictaphone” from the possible answers. The survey creator may be prompted to select or indicate the recipient of the email message, the content of the email message, the email address, etc. in text boxes displayed on the Web page 360 if the check box is checked.

In some embodiments, a response to a question in a survey may cause a survey to end or to not use of one or more questions. For example, a company may use a survey to poll potential customers. The survey may include a question that asks about the size of a potential customer's business in terms of revenue. If the customer answers with a number that is a below a threshold amount established by the survey creator, the survey may end gracefully without providing or displaying additional questions and without indicating to the survey taker that the potential customer does not meet the criteria desired by the company.

As another example, suppose that a credit card issuer includes a yes/no survey question that asks “Do you expect to use your credit card within the next twelve months?” in a survey sent to its current customers. If any person taking the survey indicates “no” to the question, the server 104 may send an email message or other communication to one or more designated people and/or designated email addresses previously supplied by the survey creator. The survey creator also may have supplied the notification message. In addition, other forms or formats of notifications may be used in addition to, or as an alternative to, an email message.

In some embodiments, a survey creator may be able to indicate or specify a logic branch for one or more questions in a survey. For example, the survey creator may be able to indicate a redirection or skipping of one or more questions based on a survey takers response to a previous question. As a more specific example, the survey creator may designate that if the survey taker has answered “yes” to question 5, the survey taker is presented with questions 5A, 5B, and 5C. However, if the survey taker answers “no” to question 5, the survey taker is not presented with questions 5A, 5B, and 5C. Alternatively, the survey taker may be presented with question 5D. As another example, a survey taker may skip one or more questions based on an answer to a previous question.

In some embodiments, the step 202 may include the survey having at least one associated invitee and/or at least one associated approver and/or the survey application or server 104 receiving data indicative of one or more invitees and/or one or more approvers. An invitee may be a person or application to whom a completed survey is to be sent. An approver may be a person that needs to approve or review a survey prior to the survey being sent to an invitee.

In some embodiments, the server 104 may store or otherwise have or have access to information (e.g., names, identifiers, contact information) for one or more potential invitees and/or approvers. Such information may be developed or maintained by the server 104 or another application or device. For example, a human resources application (e.g., the application 113) may develop and maintain information (e.g., names, email addresses, roles) for one or more employees of a company and may store the information in the database 112. The server 104 may access or retrieve the information from the database 112 for use in providing lists of potential invitees or approvers to a survey creator.

In some embodiments, the user may be able to indicate or select a group of invitees by a group name, as opposed to indicating or selecting the individual invitee members of the group. Similarly, the user may be able to indicate or select a group of approvers by a group name or other identifier (e.g., charge code, role, reporting hierarchy, location, employee level, manager name, job description, security level, customer affiliation), as opposed to indicating or selecting the individual approver members of the group. In this manner, neither the user nor the server 104 needs to know who is a member of the group and maintenance and upkeep of the group list can be handled by another party, device, or application. In some embodiments, the server 104 or survey application may maintain the list of people indicated in the box 374 or may import or retrieve the invitee data from other applications, databases, sources, etc. In other embodiments, another application, device, or party may maintain the list of people in the groups indicated in the box 374 and provide access by the server 104 to the list. The other application, device or party also may maintain contact information (e.g., email addresses, facsimile numbers) for the people in the groups indicated in the box 372. As shown by this example, in some embodiments, the survey generating application operating on the server 104 may be able to access other information maintained in or by different sources, applications, databases, etc.

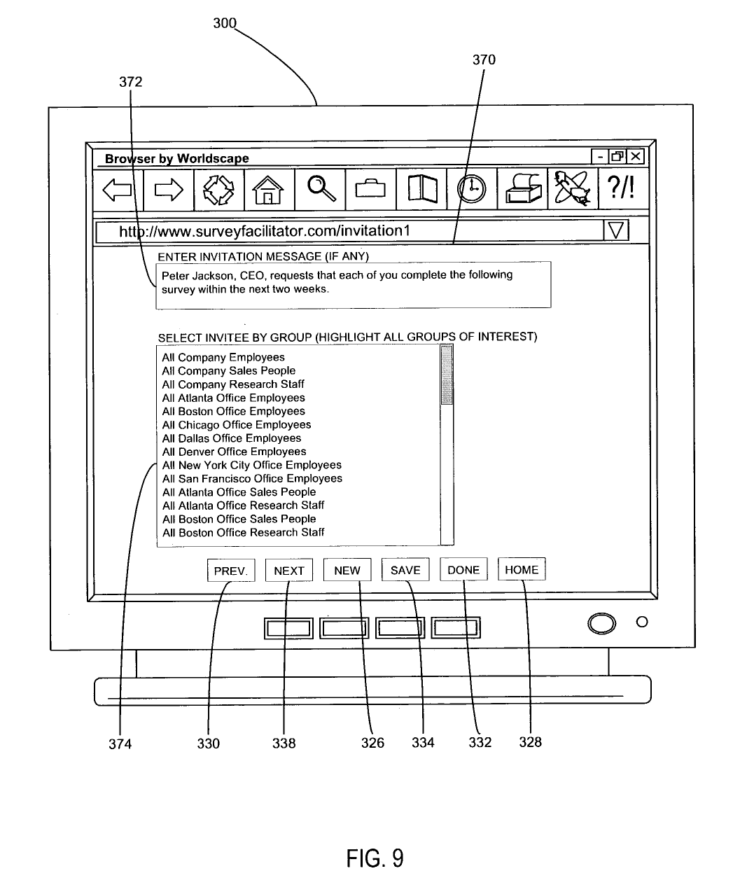

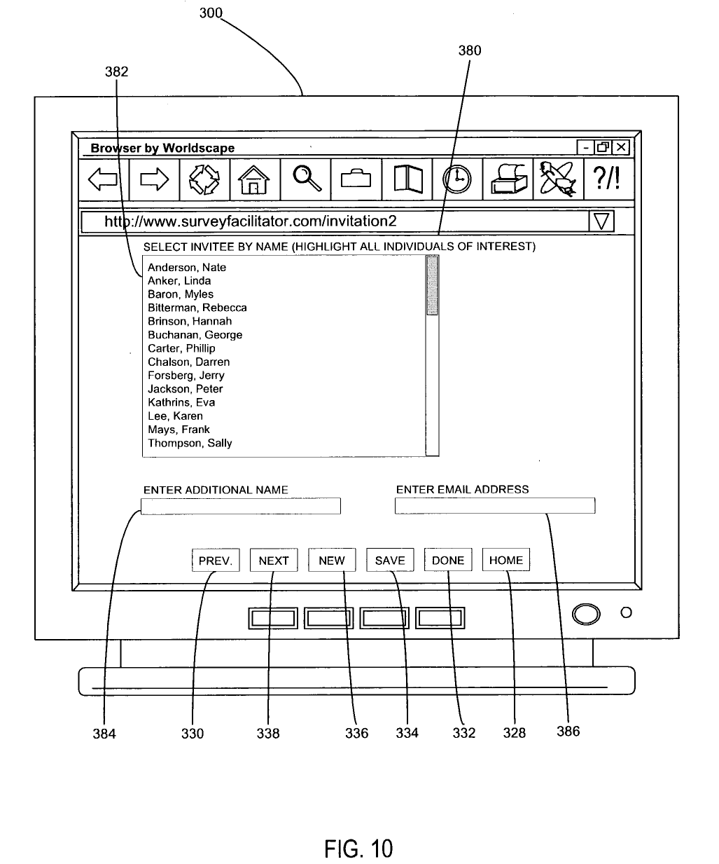

Now referring to FIGS. 9 and 10, a representative example is provided of how one or more invitees for a survey may be selected or indicated. A Web page 370 illustrated in FIG. 9 allows a user creating a survey to enter a message to be used in an invitation in a text block 372. The Web page 370 may be served by the server 104 or be part of a Web site hosted by the server 104. The Web page 370 also may allow the user to indicate one or more groups of interest, wherein the members are the potential recipients of an invitation to take the survey. As some people may be members of more than one group (e.g., a person in the “All Company Sales People” group also is in the “All Company Employees Group”), the sever 104 or the server application may eliminate duplicate member entries from different groups prior to sending out invitations so that no invitee receives more than one invitation to participate in the survey. As the user may not know names or contact information for all members of a particular group, the user can select a group knowing that the server 104 or survey application has access to such information. For example, if the user wants to send the survey to all employees of a company, the user may select “All Company Employees” in the box 374. If the user only wants to send the survey to certain employees in certain locations, the user may select “All Dallas Office Employees” and “All Denver Office Employees” in the box 374. In some embodiments, the Web page 370 may provide the survey creator with a list of most recently or most often used potential groups of invitees, with the most recent or most often groups used listed at the beginning or top of the list. As another example of a potential group of invitees, the block 374 may include an option entitled “All Employees Who Report to Bill Smith”, “All Managers Level 2 and Above”, etc.

In some embodiments, a user way want or may be offered the opportunity to send a survey to specific people, which may be in addition to or instead of the people selected as part of a group in the box 374. For example, now referring to FIG. 10, a Web page 380 includes a box 382 in which individual people are listed that can be selected as an invitee for the survey. The Web page 380 may be served by the server 104 or be part of a Web site hosted by the server 104. The user may be able to select more than one name from the box 382. In some embodiments, the server 104 or survey application may maintain the list of people indicated in the box 382. In other embodiments, another application, device, or party may maintain the list of people indicated in the box 382 and provide access by the server to the list. The other application, device or party also may maintain contact information (e.g., email addresses, facsimile numbers) for the people indicated in the box 382. In some embodiments, the user may be able to enter a specific name or other identifier in a text box 384 and provide an email address or other contact information in a text box 386 for the invitee indicated in the text box 384. In some embodiments, the block 374 may provide the survey creator with a list of most recently or most often used potential invitees, with the most recent or most often invitees used listed at the beginning or top of the list. In some embodiments, the Web page 380 may allow the survey creator to search for an invitee by name, title, location, function, role, seniority, etc.

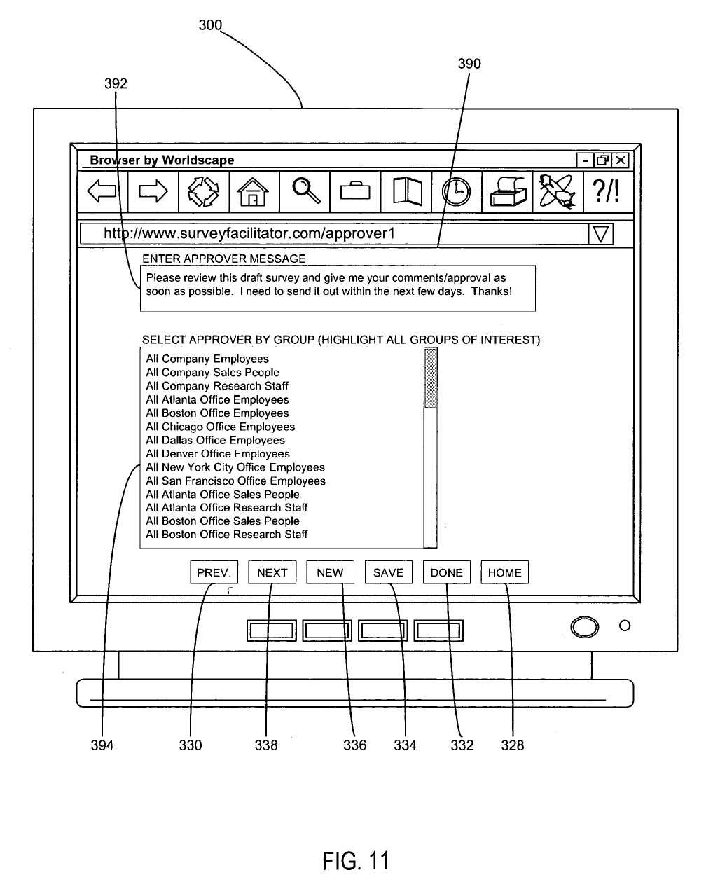

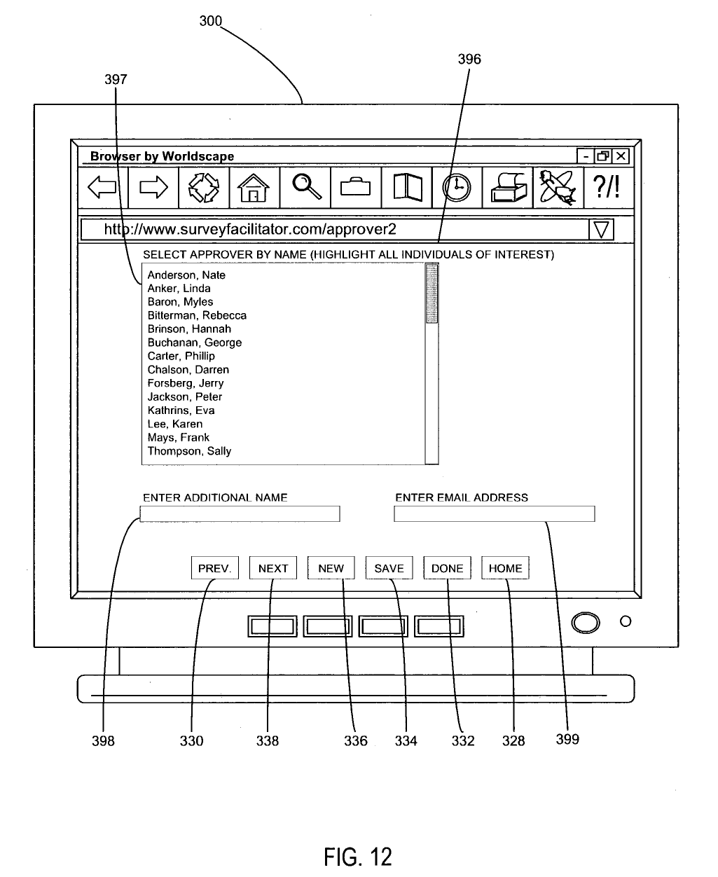

Now referring to FIGS. 11 and 12, a representative example is provided of how one or more approvers for a survey may be selected or indicated. A Web page 390 illustrated in FIG. 11 allows a user creating a survey to enter a message in text block 392 to be used in a communication with an approver for the survey. The Web page 390 may be served by the server 104 or be part of a Web site hosted by the server 104. The Web page 390 also may allow the user to indicate one or more groups of interest, wherein the members are the potential approvers of the survey by highlighting the appropriate group(s) in box 394. As some people may be members of more than one group (e.g., a person in the “All Company Sales People” group also is in the “All Company Employees Group”), the sever 104 or the server application may eliminate duplicate member entries from different groups prior to sending out invitations so that no invitee receives more than one invitation to participate in the survey, as previously discussed above with regard to the invitees. As the user may not know names or contact information for all members of a particular group, the user can select a group knowing that the server 104 or survey application has access to such information, which may be maintained or developed by another application, device, etc. In some embodiments, the Web page 390 may provide the survey creator with a list of most recently or most often used potential groups of approvers, with the most recent or most often groups used listed at the beginning or top of the list.

In some embodiments, a user way want or may be offered the opportunity to send a survey to one or more specific approvers, which may be in addition to or instead of the people selected as part of a group in the box 374. For example, now referring to FIG. 12, a Web page 396 includes a box 397 in which individual people are listed that can be selected as an approver for the survey. The user may be able to select more than one name from the box 397. In some embodiments, the server 104 or survey application may maintain the list of people indicated in the box 392. In other embodiments, another application, device, or party may maintain the list of people indicated in the box 397 and provide access by the server 104 to the list. The other application, device or party also may maintain contact information (e.g., email addresses, facsimile numbers) for the people indicated in the box 397. In some embodiments, the user may be able to enter a specific name or other identifier in a text box 398 and provide an email address or other contact information in a text box 399 for the approver indicated in the text box 398. In some embodiments, the Web page 396 may provide the survey creator with a list of most recently or most often used potential approvers, with the most recent or most often potential approvers used listed at the beginning or top of the list. The Web page 396 may be served by the server 104 or be part of a Web site hosted by the server 104.

As illustrated by the FIGS. 9-12 and the description above, in some embodiments, data regarding one or more potential invitees and/or one or more potential approvers may be accessible to or retrievable by the server 104, even if the server 104 is not responsible for updating or otherwise maintaining such data. For example, other applications may create the data store the data in the database 112 which can be accessed by the server 104. Thus, for example, a company's databases of employees, customers, suppliers, etc. may be used or accessed by the server 104 or operate in conjunction with the server 104 to facilitate creation of a survey, identify or communicate with potential invitees, etc.

While the examples discussed above in relation to FIGS. 9-12 are directed to invitees and approvers, similar Web pages or windows may be used to allow a survey creator to indicate one or more people, groups of people, applications, or groups of applications, that may be granted or provided access to the results of a survey, sent the results of a survey, etc. Such people or application(s) may be allowed to access or view a table, database, Web site, or other resource where results of the survey are stored or may be sent a copy of a report relating to the survey.

In some embodiments, the server 104 may receive or retrieve data indicative of or relating to an invitee and/or an approver (e.g., names, email addresses) from an application or database operating on another device. For example, an application mining a company's marketing database may create or provide the list of potential invitees to the server 104 for use with a survey.

Referring once again to FIG. 3, during a step 410 the server 104 provides a message or other data indicative of a request to one or more approvers to review the survey and/or consent to the survey. The server 104 may provide the data directly or indirectly to the approver(s) or to another application or device that will provide the request to the approver(s). For the example survey discussed above, the message or other data may include the information entered into the text block 392 by the user or some other designated or default message. The server 104 may provide the message or data in an email message, instant message communication, facsimile transmission or other electronic communication. In some embodiments, the server 104 may access or work in conjunction with a database or other resource or application (e.g., an email program) to send out the message or data to an approver.

In some embodiments, a request or other message sent to an approver may include a link or other electronic address providing access to the survey to be reviewed. An approver may click on the link or access the electronic address to access the survey. The server 104 may provide the survey via the link to an approver in real time or near real time. As a survey creator updates and modifies a survey, the approvers may be able to see the updates and modifications via the link or electronic address that can direct the approvers to the survey. Alternatively, as a survey creator updates and modifies a survey, the server 104 may send new links or electronic addresses for new variations of the survey to the approvers.

During a step 412 the server 104 provides a message or other data indicative of an invitation to take a survey to one or more invitees. The server 104 may provide the invitation directly or indirectly to the invitee(s) or to another application or device that will provide the request to the invitee(s). For the example survey discussed above, the invitation may include the information entered into the text block 372 by the user or some other designated or default message. The server 104 may provide the invitation in or as part of an email message, instant message communication, facsimile transmission or other electronic communication. In some embodiments, the server 104 may access or work in conjunction with a database or other resource or application (e.g., an email program) to send out an invitation to an invitee. In some embodiments, each recipient of an invitation to take the survey may receive the invitation in a way such that the recipient is unaware of other recipients of the invitation. For example, each invitee for a survey may be sent an email message under a separate SMTP (Simple Mail Transfer Protocol) session such that no invitee knows what other invitees also are receiving the invitation.

In some embodiments, the method 200 may include a step during which the server 104 receives or must receive a response from or regarding an approver regarding the survey before the step 412 can occur. For example, the server 104 may receive a message or other indication directly or indirectly from an approver that the approver has consented to, or at least reviewed, the survey. As another example, the server 104 may receive a message or other indication that one or more approvers have or have not given approval for a survey. More specifically, another application or a person might set a flag, database entry value, etc., or send a message or other data indicating approval or disapproval to send out an invitation to take a survey and/or a reason for the approval or disapproval.

In some embodiments, an invitation sent during the step 412 may include a URL (Uniform Resource Locator), table identifier, electronic address, link, or other indicator regarding where an invitee needs to go to access a survey mentioned in an invitation. For example, an invitation might include a URL or other Web page identifier or link such as “http://www.surveyfacilitator.com/survey621user459103” that indicates a specific electronic address where access to the survey can be obtained. The designator “621” may indicate the specific survey while the designator “459103” may be an identifier associated with the specific invitee. Since the designator “459103” is used in the link, a person accessing the link “http://www.surveyfacilitator.com/survey621user459103” may be assumed to be the invitee. Thus, tracking the results from a specific invitee is possible without asking for information from the invitee.

In some embodiments, the server 104 may track that a specific person has responded to or completed a survey without actually tying the person's responses to the survey to their name. For example, assume that one hundred people have been invited to take a survey, of which seventy respond. The server 104 may track which seventy invitees have responded, without tracking their specific responses to questions/requests in the survey.

Clicking or selecting a URL, link or other indicator in an invitation may allow an invitee to access the survey associated with the invitation or a Web page on which the survey can be accessed, taken, etc. In some embodiments, the URL or other indicator of the location of the survey, or the invitation that includes the URL or other indicator, may include a time stamp indicating the date/time of creation of the survey, the date/time of the sending of the invitation. If a survey is to be provided anonymously, the URL or other indicator of the location might not include an identifier associated with a specific invitee, but may include an identifier associated with the survey. In addition, the identifier associated with the survey may indicate the generation or version of the survey. For example, if the same survey is sent out at two different times, the first time will be considered as the first generation of the survey and the second time will be considered the second generation of the survey. Thus, responses from the same survey takers can be tracked for both generations of the same survey.

In some embodiments, a response from an invitee to a survey might be associated with a time stamp regarding the date the survey was created, a time stamp regarding the date an invitation was sent to the invitee regarding the survey, and/or a time stamp regarding when the invitee accessed and/or completed the survey. In this manner, a survey taker or respondent may be able to take the survey more than once, with different time stamps being associated with the survey and/or the responses to the survey provided by the survey taker.

During a step 414, the server 104 allows or otherwise facilitates access to the survey to the invitee. In some embodiments, the user may need to enter or present a password or complete some other security function in order to access the survey. The password may be included in the invitation sent to the invitee or may be provided to the invitee by some other manner. Alternatively, the password may be an identifier (e.g., social security number, employee identification number) that the employee is assumed to know or have access to. A password may be generic for an entire survey, so that it allows control of access to the survey by survey takers without compromising the anonymity of the survey takers.

In some embodiments, allowing access to a survey may include deploying the survey in one or more of a variety of ways such as, for example, an HTML or other file hosted on or provided by the server 104 or another device, an HTML or other file hosted on or provided by internal server (which might be the server 104) or other device inside a corporate firewall, a run-time or on-demand rendering or creation of the survey on a Web site or intranet site, HTML or other code emailed or otherwise sent to a party or device for embedding into a Web page, export or transmission via a designated format or communication channel, etc. In some embodiments, a survey creator or other person may determine how the survey is to be deployed (e.g., as an HTML page or file, dynamically generated JSP page) and/or how the survey is to be exposed or made accessible to survey takers. Thus, in some embodiments, the method 200 may include receiving data indicative of how the survey is to be deployed or otherwise determining how the survey is to be deployed or made accessible.

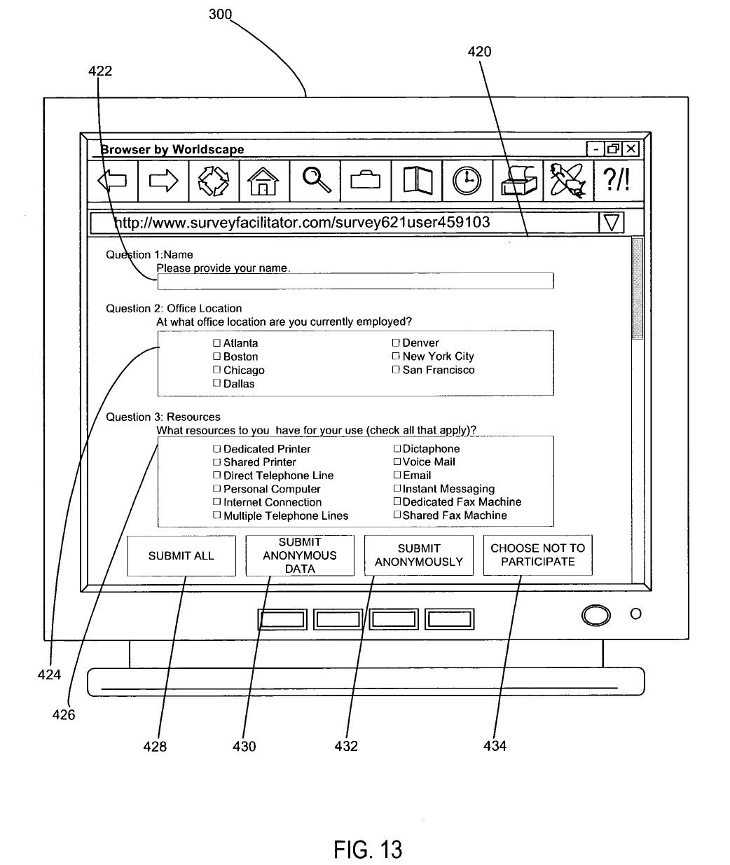

As a specific example of a survey might be provided, now referring to FIG. 13, a representative Web page 420 is provided that provides the survey discussed above and allows an invitee to enter or select responses via boxes 422, 424, 426. The invitee may scroll down the Web page 420 to view and answer other questions or requests. In some embodiments, the Web page 420 may include hyperlinks or hypertext-linked numbers that allow direct access to any question in the survey. By providing access to the survey via a Web site, intranet site, or other electronic resource accessed by the survey taker via a conventional browser application, the survey taker may not need to have any special software, cookies, plug-ins, etc. installed on his or her user device and all data needed to display and take the survey is stored or accessed by the server 104. The Web page 420 may be served by the server 104 or be part of a Web site hosted by the server 104.

In some embodiments, questions in a survey may be provided to a survey taker randomly Randomization of the questions may help prevent skewing of data generated from analysis of the results of the survey. The Web page 420 also may display a title (e.g., “OFFICE SUPPLY SURVEY”) and introduction to the survey if they were provided by the survey creator when the survey was created. An example survey introduction might be: “This survey is intended to gather information from all ACME Corp. locations to determine our needs for office supplies. This survey is mandatory for all administrative assistants and should take you no more than five minutes to complete.”

As previously discussed above in relation to FIG. 6, a Web page used to create a survey may include a BUILD button and a VIEW button. Clicking a VIEW button on the Web page 360 (not shown) may cause the three questions illustrated in FIG. 13 to be displayed to the survey creator.

In some embodiments, the Web page 420 may include a DONE or SUBMIT button that allows the survey taker to indicate that he or she is finished taking the survey. If one or more questions or requests in the survey remain unanswered or unresponded to, the Web page 420 or another window may prompt the survey taker to complete or respond to the specific question or survey. In some embodiments, in order for a survey response to be considered valid or complete, a survey take may be required to respond to some or all of the questions or requests in the survey. For example, the survey taker may not be able to see or select the DONE or SUBMIT buttons until answering some or all of the questions in the survey.

In some embodiments, the Web page 420 may include two or more types of “submit” buttons, such as buttons 428, 430, 432, and 434. After completing a survey, a survey taker may select button 428 to submit the survey taker's answers and the survey taker's identity to the server 104. Alternatively, the survey taker may select button 430 to submit his or her answers anonymously to the server 104, while the server 104 updates a separate record to indicate that the survey taker responded to the survey in a way that does not link the survey taker to the survey taker's answers. Thus, it can be determined which invitees for a survey responded to the survey, even if specific answers by a specific survey taker are not associated with the survey taker. As another option, the survey taker may select button 432 to submit answers to a survey anonymously such that no data about the survey taker's identity is maintained. Thus, it may not be known which invitees for a survey have responded to the survey. In a further option, the survey taker may select button 434, thereby indicating that the survey taker does not wish to participate in the survey or provide a response to the survey. In this option, selection of the button 434 provides an indication that the survey taker at least received and possibly viewed the survey. After selecting the button 434, the survey taker also may be a provided a text block in which the survey taker can enter text regarding why the survey taker has chosen not to participate.

In some embodiments, the types of submit buttons that appear to a survey taker on a survey may be designated or selected by the survey creator when creating the survey. In other embodiments, the types of submit buttons that appear to the survey taker may be set by default, by an administrator, or by a person designated as having the power to establish such options.

As previously mentioned above, in some embodiments a survey creator may be able to indicate whether or not the server 104 or the code that operates the survey is to validate a response to a survey question. If a survey taker's response is improper or incomplete (e.g., nine digits are not provided for a social security number, five digits are not provided for a zip code), the server 104 or the survey code may display a pop-up window or other message to indicate that survey taker has not provided a proper response to the question.

In some embodiments, a survey creator may be able to control other aspects of a survey. For example, the survey creator may be able to specify the format to be used for a survey (e.g., font, margins, colors for questions, colors for answers), specify specific times that specific invitees can take a survey (e.g., during business hours only, during a weekend, only once), etc.

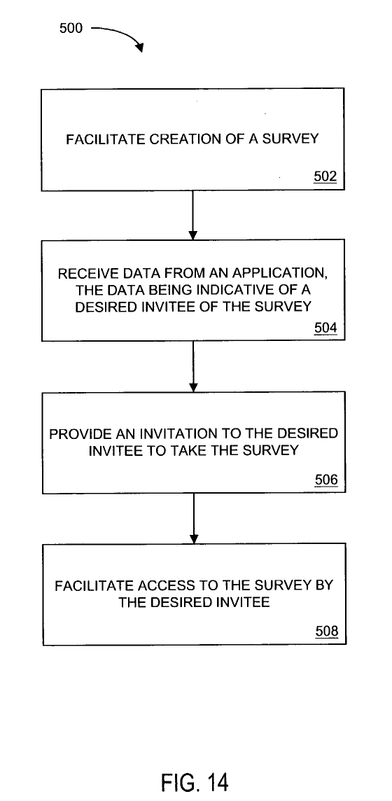

Reference is now made to FIG. 14, where a flow chart 500 is shown that represents the operation of a second embodiment of the present invention. The particular arrangement of elements in the flow chart 500 is not meant to imply a fixed order to the steps; embodiments of the present invention can be practiced in any order that is practicable. In some embodiments, some or all of the steps of the method 500 may be performed or completed by the server 104 or another device. For purposes of elaboration, but not limitation, the server 104 is assumed to be implementing the method 500. Reference to the server 104 performing the method 500 also will include a survey application or other software operating on or in conjunction with the server 104 to implement one or more steps of the method 500. In some embodiments, the method 500 may include some or all of the variations previously discussed above in relation to the method 200.

Processing begins at a step 502, during which the server 104 facilitates creation of a survey. The step 502 is similar to the step 202 previously discussed above.

During a step 504, the server 104 receives or retrieves data from one or more external or enterprise applications (e.g., the application 103) or databases, the data being indicative of one or more desired invitees for the survey created during the step 502. In some embodiments, the data may be or be included in an email message, electronic file, database record or table, XML or FTP transmission, facsimile transmission, or other electronic communication. In some embodiments, the application sending or providing the data is an application operating independently of the server 104 and/or software operating on the server 104. For example, a user may access the server 104 to create a survey to send to potential customers of a company. An application operating on a separate device may generate potential invitees for the survey from various sources and may be unaware of the survey or uninvolved in the creation of the survey. The application may send information to the server 104 regarding the potential invitees the application has identified, contact information for the invitees, etc. or otherwise allow the server 104 to retrieve the information created by the application.

During a step 506, the server 104 may send an invitation to one or more of the invitees for which the server 104 received data and/or contact information during the step 504. The step 506 is similar to the step 412 previously discussed above.

During a step 508, the server 104 may facilitate or otherwise allow access to the survey by one or more invitees. The step 508 is similar to the step 414 previously discussed above.

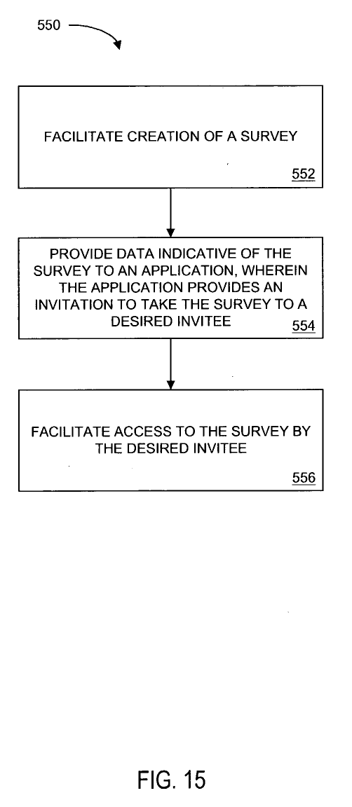

Reference is now made to FIG. 15, where a flow chart 550 is shown that represents the operation of a third embodiment of the present invention. The particular arrangement of elements in the flow chart 550 is not meant to imply a fixed order to the steps; embodiments of the present invention can be practiced in any order that is practicable. In some embodiments, some or all of the steps of the method 550 may be performed or completed by the server 104 or another device. For purposes of elaboration, but not limitation, the server 104 is assumed to be implementing the method 550. Reference to the server 104 performing the method 550 also will include a survey application or other software operating on or in conjunction with the server 104 to implement one or more steps of the method 550. In some embodiments, the method 550 may include some or all of the variations previously discussed above in relation to the method 200.

Processing begins at a step 552, during which the server 104 facilitates creation of a survey. The step 552 is similar to the step 202 previously discussed above.

During a step 554, the server 104 provides data indicative of the survey to another application. For example, the server 104 might provide information descriptive of the survey, information description of one or more questions/requests in the survey, information descriptive of a location of the survey (e.g., computer address, electronic address, database record, table entry), information indicative of the date of creation of the survey, information indicative of the application or other user that created the survey, information indicative of one or more approvers and/or invitees associated with the survey, information regarding an invitation to be sent to one or more invitees regarding the survey, etc. In some embodiments, the server 104 may provide the data in or as part of an email message, electronic file, database record, XML or FTP transmission, facsimile transmission, or other electronic communication.

Once the application receives some or all of the data from the server 104, the application may send an invitation to one or more invitees to take the survey. In some embodiments, the application may wait to receive approval before sending out the survey. In some embodiments, either the server 104, the application, and/or some other party or device may identify or otherwise determine the invitee(s) associated with the survey, the invitation to be used, etc. With the method 550, the server 104 and the user creating the survey is able to pass along the responsibility or process of sending out invitations to take the survey to the application. For example, in some embodiments, a user creating a survey may not be involved in making the decision as to who and when to send out invitations to the survey. The application may make some or all of these decisions on behalf of the user and/or the server 104.

During the step 556, the server 104 facilitates or otherwise allows access to the survey. The step 556 is similar to the step 414 previously discussed above.

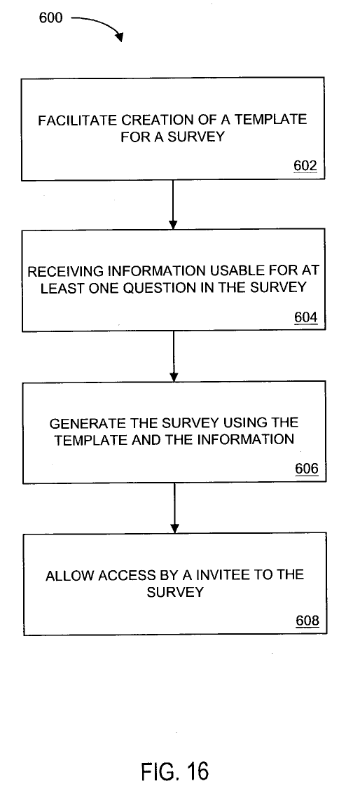

Reference is now made to FIG. 16, where a flow chart 600 is shown that represents the operation of a fourth embodiment of the present invention. The particular arrangement of elements in the flow chart 600 is not meant to imply a fixed order to the steps; embodiments of the present invention can be practiced in any order that is practicable. In some embodiments, some or all of the steps of the method 600 may be performed or completed by the server 104 or another device. For purposes of elaboration, but not limitation, the server 104 is assumed to be implementing the method 600. Reference to the server 104 performing the method 600 also will include a survey application or other software operating on or in conjunction with the server 104 to implement one or more steps of the method 600. In some embodiments, the method 600 may include some or all of the variations previously discussed above in relation to the method 200.

Processing begins at a step 602 during which the server 104 facilitates creation of a template for a survey. The step 602 is similar to the step 202 previously discussed above. In some embodiments, creating a survey template may include creating some of the parts of a survey, but not all of the parts. In some embodiments, a survey template may be used to create more than one survey. For example, a user may create the questions for the survey, some of which may include multiple choice questions or other questions wherein a responder must select from among several possible answers. The user may create the template by specifying or indicating the question, but might not fill in any or some of the possible selectable answers to the question. As another example, a user might create a survey, but not indicate any or all of the invitees associated with the survey, any or all of the approvers associated with the survey, etc. Thus, the survey remains uncompleted. As another example, the user might specify the format to be used for a survey (e.g., font, margins, spacing, colors for questions, colors for answers), but not actually provide the questions for the survey.

During a step 604, the server 104 receives data or other information that may be usable with the survey template created during the step 602. For example, the server 104 may receive information regarding one or more questions for a survey, one or more possible answers to be used with a question in the survey, one or more invitees for the survey, one or more approvers for the survey, etc. The server 104 can then use the information to create a survey using the template created during the step 602.

During a step 608, the server 104 may allow or facilitate access to the survey created during the step 606. The step 608 is similar to the step 414 previously discussed above.

In some embodiments, the server 104 may provide an invitation to one or more invitees to take the survey in a manner similar to the step 412 previously discussed above.

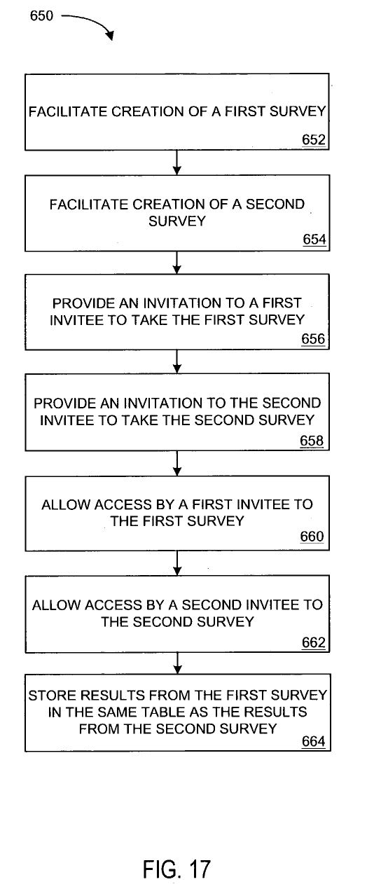

Reference is now made to FIG. 17, where a flow chart 650 is shown that represents the operation of a fifth embodiment of the present invention. The particular arrangement of elements in the flow chart 650 is not meant to imply a fixed order to the steps; embodiments of the present invention can be practiced in any order that is practicable. In some embodiments, some or all of the steps of the method 650 may be performed or completed by the server 104 or another device. For purposes of elaboration, but not limitation, the server 104 is assumed to be implementing the method 650. Reference to the server 104 performing the method 650 also will include a survey application or other software operating on or in conjunction with the server 104 to implement one or more steps of the method 650. In some embodiments, the method 650 may include some or all of the variations previously discussed above in relation to the method 200.

Processing begins at a step 652 during which the server 104 facilitates creation of a first survey. The step 652 is similar to the step 202 previously discussed above.

During a step 654, the server 104 facilitates creation of a first survey. The step 654 is similar to the step 202 previously discussed above.

During a step 656, the server 104 provides an invitation to a first invitee to take the first survey. The step 656 is similar to the step 410 previously discussed above. In some embodiments, the step 656 may occur before the step 654.

During a step 658, the server 104 provides an invitation to a second invitee to take the second survey. The step 656 is similar to the step 410 previously discussed above. In some embodiments, the step 658 may occur before the step 656.

During a step 660, the server 104 may allow or facilitate access to the first survey by the first invitee. The step 660 is similar to the step 414 previously discussed above. In some embodiments, the step 660 may occur before the step 654 and/or the step 658.

During a step 662, the server 104 may allow or facilitate access to the second survey by the second invitee. The step 660 is similar to the step 414 previously discussed above. In some embodiments, the step 660 may occur before the step 656 and/or the step 660.

During a step 664, the server 104 stores some or all of the results for the first survey and some or all of the results for the second survey in the same table or other electronic record. A single table provides for capture of data responses without having to allow table creation privileges in a database storing the table or by the server 104 or other device. In addition, appending records to an existing table instead of allowing the creation of a new table may provide increase security to the response data.

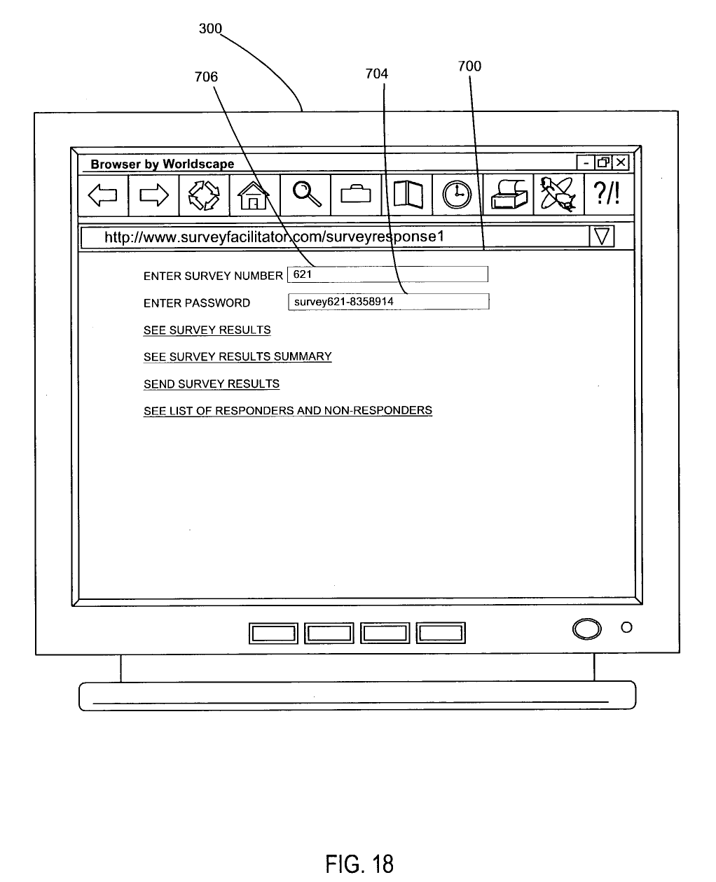

In some embodiments, an application or other software or device used to facilitate creation or use of a survey might provide many other functions or capabilities. For example, now referring to FIG. 18, a Web page 700 may allow a user (e.g., the user who created the survey, an approver, a user who is allowed access to the results) to view information regarding a survey. The Web page 700 may include a survey number text block 702 that may allow the user to entry in a code or other identifier (e.g., “621”) for a survey of interest. In addition, as access to survey results or other information may be password protected, the Web page 700 may include a text block 704 that may allow the user to enter in a password or other security identifier that is necessary for the user to be allowed access to the survey results or other information.

As illustrated in FIG. 18, the Web page 700 may allow the user to “SEE SURVEY RESULTS”, “SEE SURVEY RESULTS SUMMARY”, “SEND SURVEY RESULTS”, or “SEE LIST OF RESPONDERS AND NON-RESPONDERS” by clicking or selecting the appropriate link. In other embodiments, the Web page 700 may provide other or different capabilities. The Web page 7000 may be served by the server 104 or be part of a Web site hosted by the server 104.

If a user selects on clicks “SEND SURVEY RESULTS”, the server 104 may send an email message, HTML document, or other communication to the user one or more previously designated or selected communication channels. Alternatively, selecting “SEND SURVEY RESULTS” may cause the server 104 to display another Web page where the user can select or indicate the scope, format, and/or channel of delivery of the results (e.g., send results in Microsoft Excel™ software format to a designated email address).

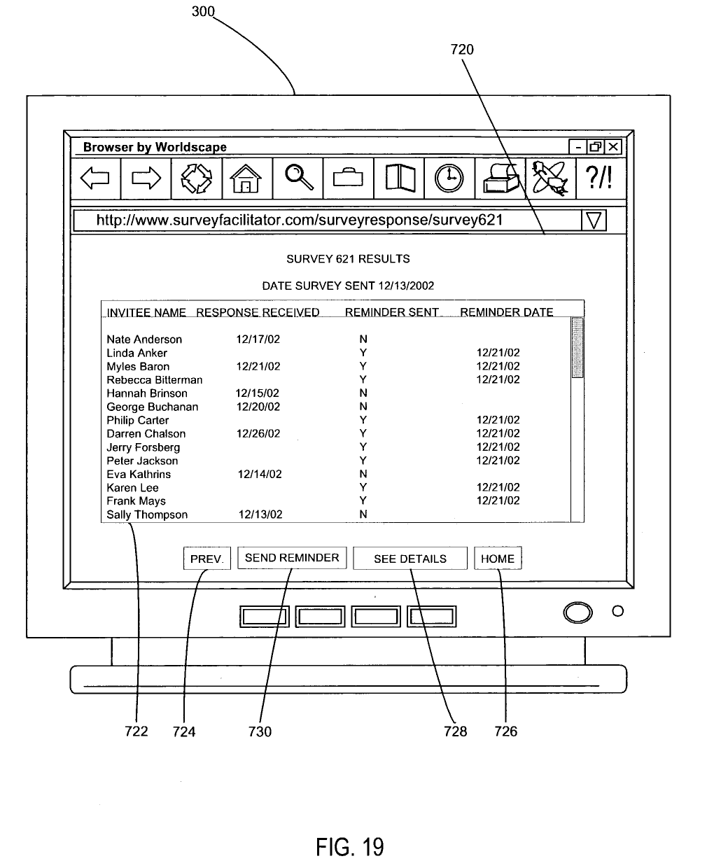

If the user clicks on or selects the “SEE LIST OF RESPONDERS AND NON-RESPONDERS” link on the Web page 700, a Web page 720 may be provided or displayed to the user, as illustrated in FIG. 19. The Web page 720 may include a box 722 in which the invitees to a survey are listed, either by name or other identifier. In some embodiments, the invitees and/or the invitees' responses may be anonymous, in which case the box 722 might not list actual invitee names. The Web page 720 may be served by the server 104 or be part of a Web site hosted by the server 104.

The Web page 720 or the box 722 may include information regarding when the survey was sent to one or more invitees, when a response, if any, was received from one or more of the invitees, an indication if a reminder was sent to one or more invitees, and *the dates the reminders where sent. For example, in some embodiments the server 104 might send an invitee a reminder regarding a survey if the invitee has not responded to or completed a survey by a specific date/time, as will be discussed in more detail below.

In some embodiments, the Web page 720 may include a PREV. button 724, selection of which may take the user back to the previously viewed or displayed Web page, and/or a HOME button 726, selection of which may take the back to the Web page 700. In some embodiments, the Web page 720 may include a SEE DETAILS button 728, selection of which may display more detailed information regarding responses to a survey for one or more invitees listed in the box 722. For example, a user might select or highlight one or more of the invitees listed in the box 722 and then click on or select the SEE DETAILS button 728 to view the questions and the invitees' responses to the questions for the survey.

In some embodiments, the Web page 720 may include a SEND REMINDER button 730, selection of which may allow the user to send a customer or default reminder message. For example, a user might select or highlight one or more of the invitees listed in the box 722 and then click on or select the SEND REMINDER button 730 to send a reminder to the invitee(s). The user may be prompted to provide a reminder message or a default or previously provided reminder message might be used.

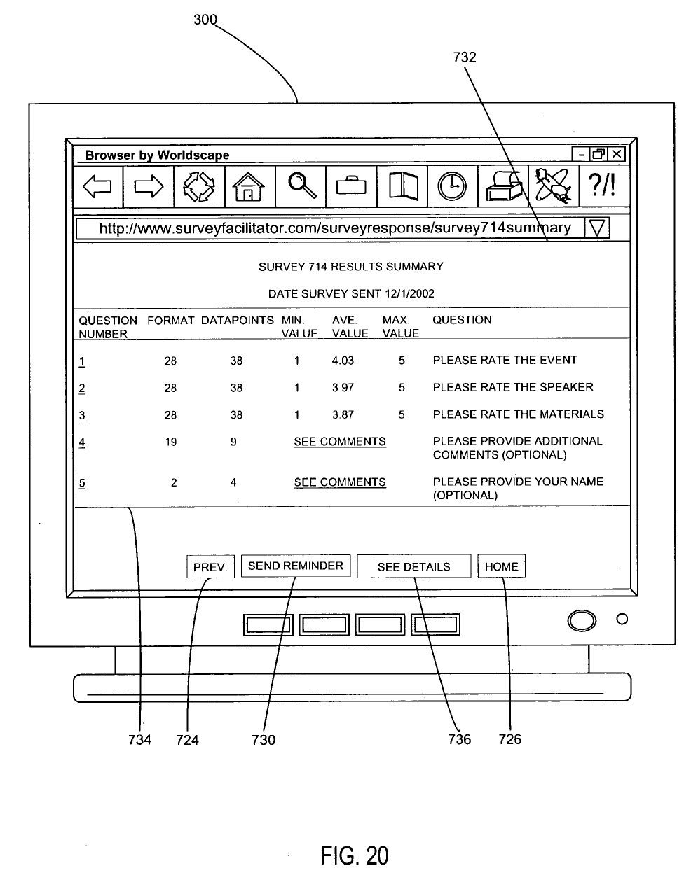

If a user selects on clicks “SEE SURVEY RESULTS SUMMARY” on the Web page 700, the server 104 may display a Web page 732, as illustrated in FIG. 20. The Web page 732 may include a block 734 in which summary results for the designated survey (in this case the survey identified as “Survey 714” are provided for each question. For example, question “1” for the survey was question type or format type “28”, thirty-eight responses (i.e., datapoints) to the survey 714 were received to question “1”. Question “1” required the survey taker to rate on a scale of one to five had the survey take liked a particular event. Questions “4” and “5” allowed survey takers to provide comments or names. The actual comments and names can be accessed by selecting or clicking on the appropriate “SEE COMMENTS” block. Other or more specific details of responses to a particular question may be obtained by clicking on or selecting “1”, “2”, “3”, “4” or “5” accordingly. Alternatively, in some embodiments, the Web page 732 may include a SEE DETAILS button 736, selection of which may display more detailed information regarding responses to a particular question in the survey. For example, a user might select or highlight one or more of the question numbers listed in the box 734 and then click on or select the SEE DETAILS button 736 to view the responses to the question in more detail. The Web page 732 may be served by the server 104 or be part of a Web site hosted by the server 104.

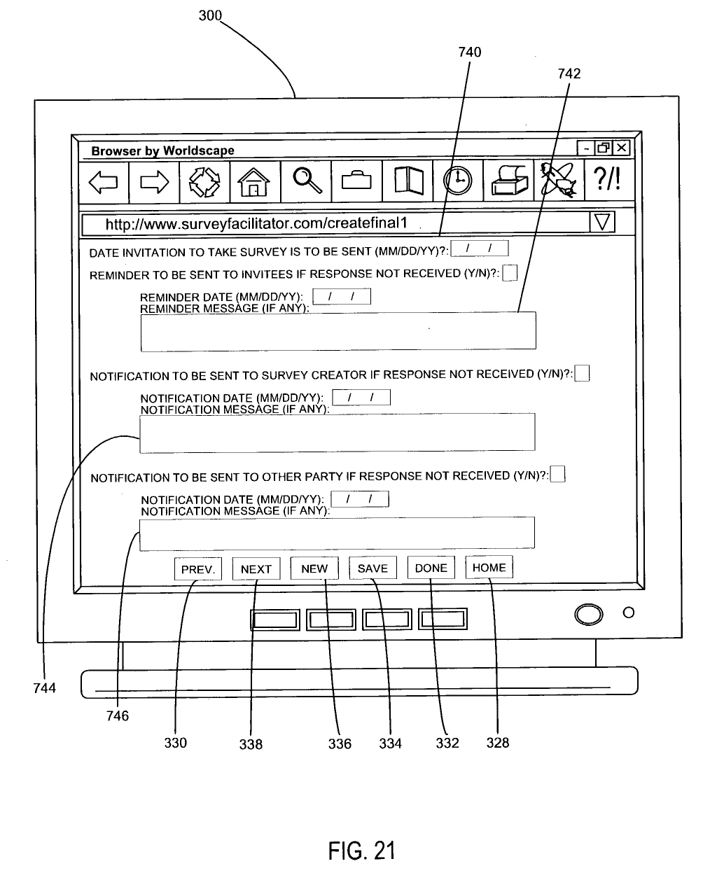

Now referring to FIG. 21, a Web page 740 is illustrated that may allow a user creating a survey to indicate a reminder and/or whether a reminder should be used. For example, a text block 742 may allow the survey creator to provide a message to be sent as a reminder if a response to a survey is not received from an invitee by a specified date. As another example, a text block 744 may allow the survey creator to provide a message that will be sent to the survey creator if a response to a survey is not received from an invitee by a specified date. Similarly, a text block 746 may allow the survey creator to provide a message that will be sent to another party (e.g., an invitee's manager, a back-up contact for the invitee) if a response to a survey is not received from an invitee by a specified date. The Web page 740 also may allow the survey creator to designate or indicate when invitations to a survey are to be sent to invitees (e.g., when the survey is to be started or launched). Invitations might not be sent regarding the survey until the launch date. The Web page 740 may be served by the server 104 or be part of a Web site hosted by the server 104.

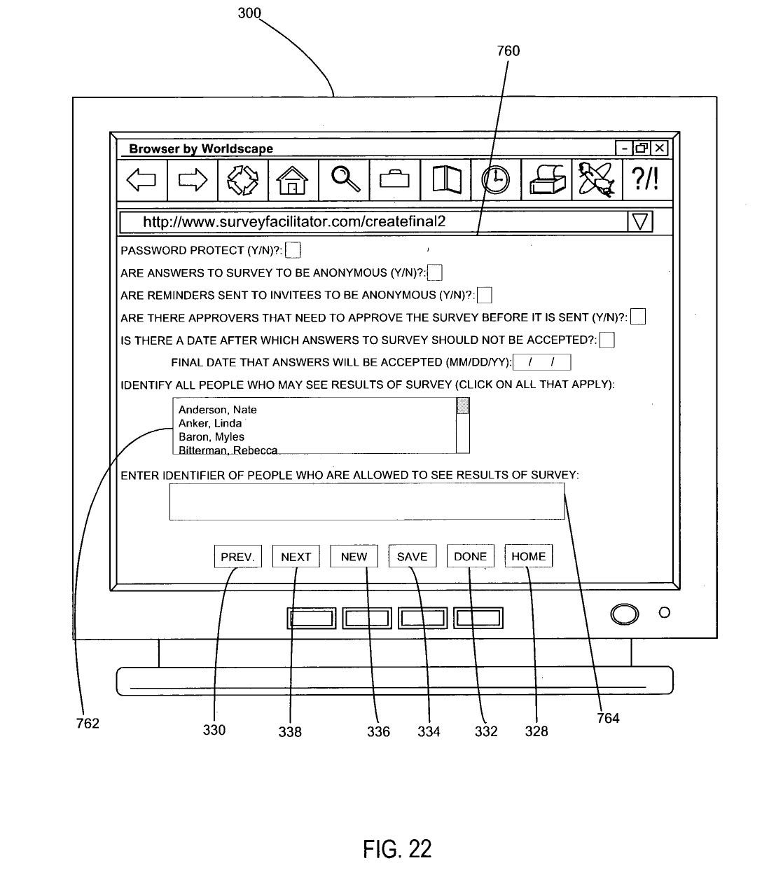

Now referring to FIG. 22, a Web page 760 is illustrated that may allow a user creating a survey to indicate whether or not answers to the survey are to be password protected, whether or not answers to the survey are to be anonymous (i.e., the invitee associated with a specific response will not be identified), whether or not a reminder to the invitee to take the survey is to be anonymous (i.e., other invitees will not know who received a reminder); whether or not there are approvers that need to approve the survey prior to invitations to the survey being sent (an indication of “Y” may lead the user to the Web page 390 or the Web page 396); and whether or not there is a date/time (i.e., an end date) after which answers or responses to the survey should not be accepted or invitees should not be allowed access to the survey. In some embodiments, if results to a survey or question are not to be allowed or accepted after a certain date, the sever 104 or survey application may remove the survey, send a note to an administrator or other party or device requesting that the survey be removed or that access to the survey be blocked or closed, etc. The Web page 760 may be served by the server 104 or be part of a Web site hosted by the server 104.

In addition, in some embodiments the Web page 760 may include a block 762 that may allow a survey creator to highlight, indicate or select one or more people or groups of people (e.g., by department, location, charge code, reporting hierarchy) that may view the results of the survey (e.g., those people who are given a password and survey identifier for the Web page 700) or who may be sent a report that includes some or all of the survey results. A report regarding results of a survey might include or be a stand alone file in a designated format emailed to a specific email address or made available via a Web browser, corporate intranet, third party reporting package or application, etc. An application (such as an enterprise application) also may receive or retrieve the results or report directly from the survey application data and/or the server 104.

The Web page 760 also may include a block 764 that may allow the survey creator to enter an identifier (e.g., name, employee identification number, social security number) for one or more people or groups of people that may view the results of the survey or who may be sent a report that includes some or all of the survey results.

In some embodiments, the Web page 760 may include additional check boxes where a survey creator can indicate whether or not the types of “submit” buttons that may appear on a survey, as previously discussed above with regard to the Web page 420 of FIG. 13. For example, the Web page 760 may allow the survey creator to indicate via check boxes whether or not one or more buttons labeled “SUBMIT”, “SUBMIT ALL”, “SUBMIT ANONYMOUSLY”, “SUBMIT ANONYMOUS DATA”, and/or “CHOOSE NOT TO PARTICIPATE” should appear with the survey.

As previously discussed above, in some embodiments, some or all of the questions in a survey may be provided to a survey taker randomly. The Web page 760 may include a check box that allows the survey creator to indicate if one or more of the questions are to be presented to the survey taker randomly.

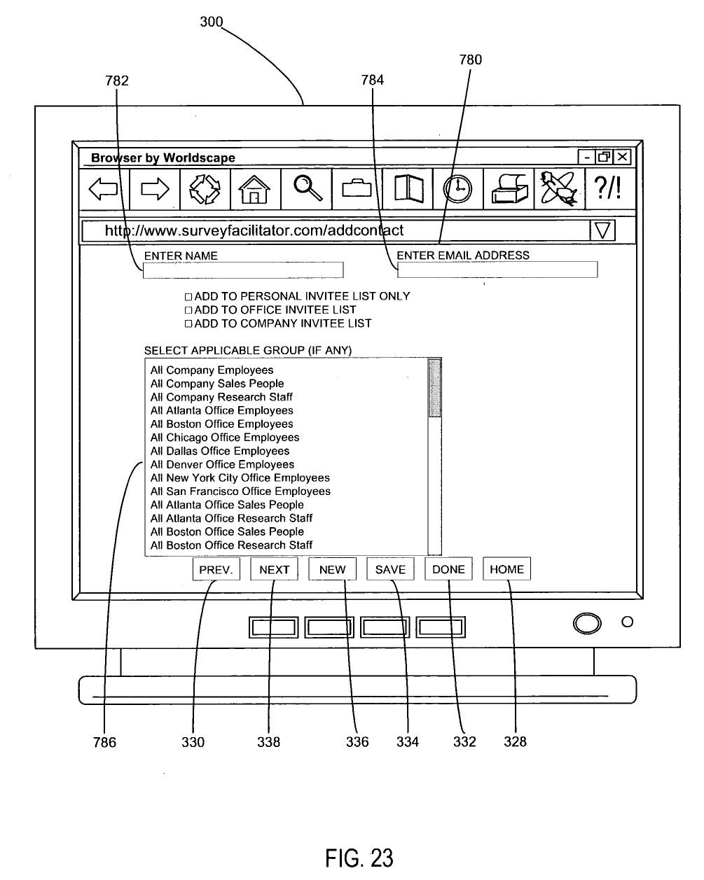

Now referring to FIG. 23, a Web page 780 is illustrated that may allow a user creating a survey or an administrator to enter a new name, email address or other contact information, etc. for a person who is being added as a potential invitee. A similar Web page may be used to enter a new potential approver. The Web pages also may allow a user to modify existing information. The Web page 780 may be served by the server 104 or be part of a Web site hosted by the server 104.

The name or identifier of the new potential invitee may be entered in a block 782 and the email address or contact information for the invitee may be added in a block 784. The user or administrator also may be able to add the new invitee to a previously created group by highlighting or selecting one or more of the groups in a block 786. For example, suppose an administrator enters the name “BRIAN JONES” in the block 782. The name and contact information for “BRIAN JONES” may be associated with the group of “All Boston Office Sales People” by selecting the appropriate group in the block 786. The name and contact information may then be automatically added to the groups “All Company Sales People” and “All Company Employees”.

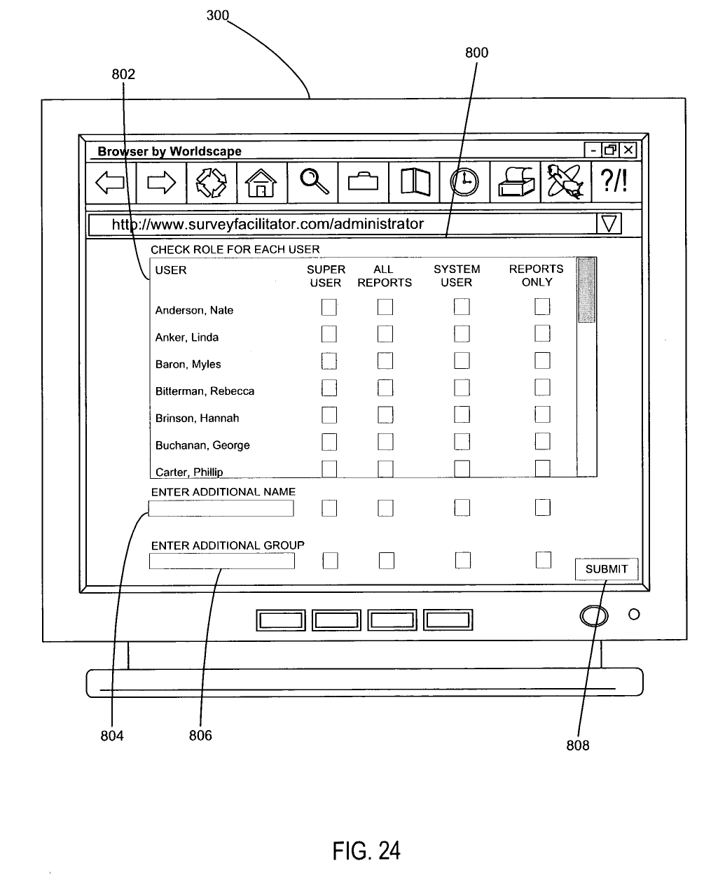

Now referring to FIG. 24, a Web page 800 is illustrated that may allow an administrator or other user to indicate a role or level of access for one or more users. For example, a user may be able to see all surveys created and all results for all surveys (e.g., a superuser). As another example, a user may be able see all the results and/or reports of all the surveys created (e.g., an all reports user). Alternatively, a user may be able to create surveys and see only the results/reports of the surveys the user has created (e.g., a system user). As a further example, a user may be able to see results/reports for only certain surveys, such as the surveys for which access by the user has been explicitly allowed by an administrator, a survey creator, etc. (e.g., a reports only user). The administrator may be able to indicate for names in a block 802 by checking the appropriate check boxes which users have which level of access or use. In addition, the Web page 800 may include blocks 804 and 806 in which the administrator might be able to enter other names or identifiers or indicate a group of people by name or identifiers and corresponding check boxes in which statuses can be indicated. The Web page 800 may be served by the server 104 or be part of a Web site hosted by the server 104.

In some embodiments, different people may be allowed different privileges based on a role assigned to or associated with them. For example, a “manager” may be able to see the results of all surveys created by employees in his or her department. Thus, different people having different roles may have different limits on survey results they can obtain or view. Other roles may allow different abilities to create surveys, clone existing surveys, access survey results, add potential invitees or approvers, etc.

In some embodiments, different statuses, roles, or levels of use for different people may provide other different benefits or capabilities. For example, a superuser may be able to delete a specific response from being used with a survey. Such a capability may be helpful to remove test responses, bad data, offensive language, etc. from survey results and reports. Results or report windows or Web pages provided to a superuser may include a button or other functionality that allows the superuser to delete some or all of the results or report.

In some embodiments, the methods disclosed herein may include determining a parameter associated with an invitee or receiving data indicative of such parameter. A parameter may include, for example, geographic location of the invitee, a demographic characteristic (e.g., age, marital status) of the invitee, the identity of the invitee, etc. The server 104 may automatically include different language (e.g., legal disclaimers or other statements) based on parameter in an invitation sent the invitee or in a survey taken by the invitee. A survey creator may indicate the parameter or provide the parameter information for an invitee or such parameter information may be stored in a database or other resource accessed by the server 104 when sending the invitation or allowing access to the survey.

Server

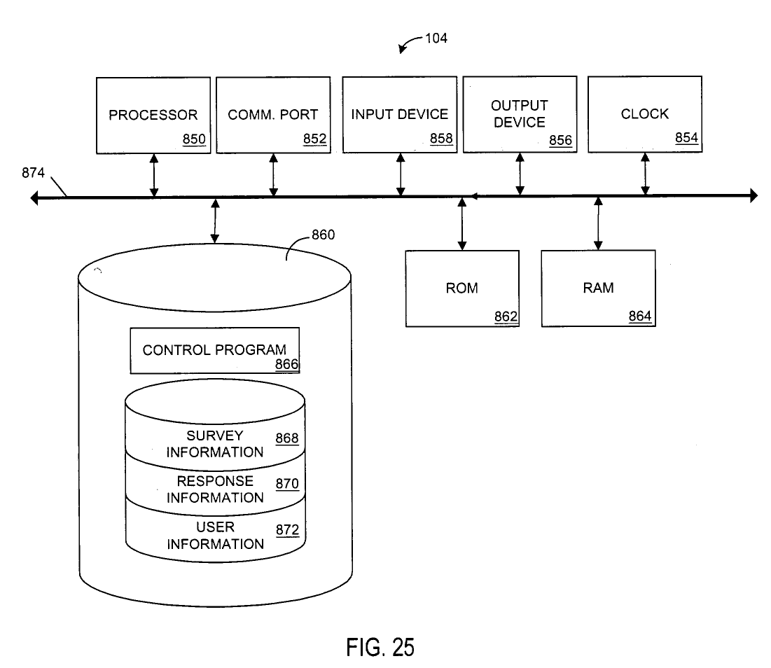

Now referring to FIG. 25, a representative block diagram of a server or controller 104 is illustrated. The server 104 may include a processor, microchip, central processing unit, or computer 850 that is in communication with or otherwise uses or includes one or more communication ports 852 for communicating with user devices and/or other devices. Communication ports may include such things as local area network adapters, wireless communication devices, Bluetooth technology, etc. The server 104 also may include an internal clock element 854 to maintain an accurate time and date for the server 104, create time stamps for communications received or sent by the server 104, etc.

If desired, the server 104 may include one or more output devices 856 such as a printer, infrared or other transmitter, antenna, audio speaker, display screen or monitor, text to speech converter, etc., as well as one or more input devices 858 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 104 may include a memory or data storage device 860 to store information, software, databases, communications, device drivers, surveys, responses, etc. The memory or data storage device 860 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 104 also may include separate ROM 862 and RAM 864.

The processor 850 and the data storage device 860 in the server 104 each may be, for example: (i) located entirely within a single computer or other computing device; or (ii) connected to each other by a remote communication medium, such as a serial port cable, telephone line or radio frequency transceiver. In one embodiment, the server 104 may comprise one or more computers that are connected to a remote server computer for maintaining databases.

A conventional personal computer or workstation with sufficient memory and processing capability may be used as the server 104. In one embodiment, the server 104 operates as or includes a Web server for an Internet environment. The server 104 preferably is capable of high volume transaction processing, performing a significant number of mathematical calculations in processing communications and database searches. A Pentium™ microprocessor, such as the Pentium III™ or IV™ microprocessor manufactured by Intel Corporation, may be used for the processor 850. Other or equivalent processors are available from Motorola, Inc., AMD, or Sun Microsystems, Inc. The processor 850 also may comprise one or more microprocessors, computers, computer systems, etc.

Software may be resident and operating or operational on the server 104. The software may be stored on the data storage device 860 and may include a control program 866 for operating the server, databases, etc. The control program 866 may control the processor 850. The processor 850 preferably performs instructions of the control program 866, and thereby operates in accordance with the present invention, and particularly in accordance with the methods described in detail herein. The control program 866 may be stored in a compressed, uncompiled and/or encrypted format. The control program 866 furthermore includes program elements that may be necessary, such as an operating system, a database management system and device drivers for allowing the processor 850 to interface with peripheral devices, databases, etc. Appropriate program elements are known to those skilled in the art, and need not be described in detail herein.

The server 104 also may include or store information regarding users, user devices, survey takers, invitees, employees, customers, applications, surveys, questions, responses, communications, etc. For example, information regarding one or more surveys may be stored in a survey information database 868 for use by the server 104 or another device or entity. Information regarding one or more responses may be stored in a response information database 870 for use by the server 104 or another device or entity and information regarding one or more users may be stored in a user information database 872 for use by the server 104 or another device or entity. In some embodiments, some or all of one or more of the databases may be stored or mirrored remotely from the server 104. In addition, in some embodiments, some or all of the information included in the survey, response and user databases may be stored in the same table, record, database, etc. In some embodiments, the server 104 might pull, extract, or retrieve information regarding one or more potential invitees and/or approvers for a survey directly from a record copy or source system.

According to an embodiment of the present invention, the instructions of the control program may be read into a main memory from another computer-readable medium, such as from the ROM 862 to the RAM 864. Execution of sequences of the instructions in the control program causes the processor 850 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 850, communication port 852, clock 854, output device 856, input device 858, data storage device 860, ROM 862, and RAM 864 may communicate or be connected directly or indirectly in a variety of ways. For example, the processor 850, communication port 852, clock 854, output device 856, input device 858, data storage device 860, ROM 862, and RAM 864 may be connected via a bus 874.

While specific implementations and hardware/software configurations for the server 104 has been illustrated, it should be noted that other implementations and hardware/software configurations are possible and that no specific implementation or hardware/software configuration is needed. Thus, in some embodiments not all of the components illustrated in FIG. 25 may be needed for a server implementing the methods disclosed herein.

User Device

As mentioned above, user device may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device may have the same structure or configuration as the server 104 illustrated in FIG. 25 and include some or all of the components of the server 104.

Databases

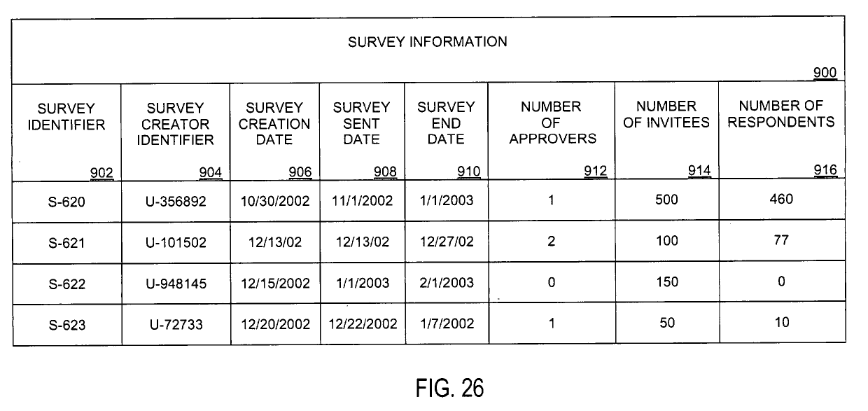

As previously discussed above, in some embodiments a server, user device, or other device may include or access a survey information database for storing or keeping information regarding one or more surveys. One representative survey information database 900 is illustrated in FIG. 26.

The survey database 900 may include a survey identifier field 902 that may include codes or other identifiers for one or more surveys, a survey creator identifier field 904 that may include codes or other identifiers associated with creators of the surveys indicated in the field 902, a survey creation date field 906 that may include information regarding when the surveys identified in the field 902 were created, a survey sent field 908 that may indicate when invitations were sent to take the surveys indicated in the field 902, a survey end date field 910 that may indicate when responses to the surveys indicated in the field 902 are no longer to be accepted or when invitees are no longer to be provided access to the surveys, a number of approvers field 910 that may indicate the number of approvers associated with the surveys indicated in the field 902, a number of invitees field 914 that may indicate the number of invitees associated with the surveys indicated in the field 902, and a number of respondents field 916 that may indicate the number of respondents for the surveys indicated in the field 902.

Other or different fields also may be used in the survey information database 900. For example, in some embodiments a survey information database 900 may include information regarding the questions for the surveys, the allowable answers for the questions, the invitations to be sent to invitees associated with the surveys, the identifiers or names of the invitees and/or approvers associated with the surveys, the locations of the surveys, the locations of results of the surveys, information regarding reminders that may be sent and when, etc.

As illustrated by the survey information database 900 of FIG. 26, the survey identified as “S-621” in the field 902 was created by the user identified as “U-101502” on Dec. 13, 2002. Invitations for the survey “S-621” also were sent on Dec. 13, 2002 to one-hundred invitees and responses to the survey “S-621” will be accepted though Dec. 27, 2002. The survey “S-621” has two associated approvers and seventy-seven responses to the survey “S-621” have been created.

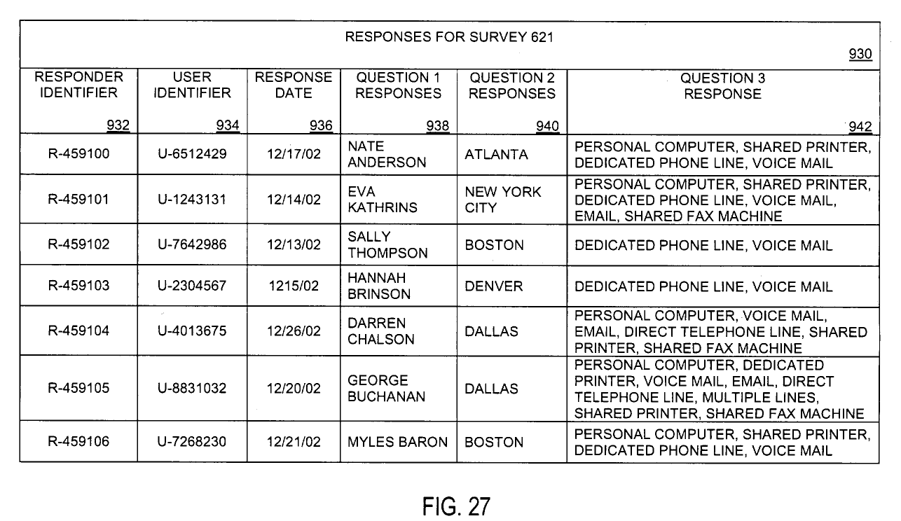

As previously discussed above, in some embodiments a server, user device, or other device may include or access a response information database for storing or keeping information regarding one or more responses to one or more surveys. Information from a response information database may be provided when a user selects or clicks on “VIEW A REPORT” from the Web page 310 in FIG. 4 or “SEE SURVEY RESULTS” from the Web page 700 of FIG. 18. A representative response information database 930 is illustrated in FIG. 27. For purposes of simplicity, only responses to the survey “S-621” are illustrated in the database 930 in FIG. 27. The database 930 may represent or use a single table in which additional results are appended as they are received. In addition, other information regarding the survey may be stored in or appended to the same table.

The response information database 930 may include a response identifier field 932 that may include codes or other identifiers for one or more responses, a user identifier field 934 that may include codes or other identifiers associated with the response identified in the field 932, a response date field 936 that may include information regarding when the responses identified in the field 932 were submitted or received, and question response fields 938, 940, and 940 that may include information regarding actual answers to questions for the responses identified in the field 932.

Other or different fields also may be used in the response information database 930. For example, in some embodiments a response information database may include information regarding how long an invitee took to complete a survey or an individual question, whether or not an invitee received a reminder to take a survey, an identifier of the creator of the survey, information regarding the questions in the survey, etc.

As illustrated by the response information database 930 of FIG. 27, the response identified as “R-459102” in the field 932 is associated with the user identified as “U-7642986” and was created or received on Dec. 13, 2002. The response “R-459102” included the answers “SALLY THOMPSON”, “BOSTON” and “DEDICATE PHONE LINE, VOICE MAIL” for the first three questions for the survey “S-621”. Some or all of the response information database 930 might be displayed if a user selected “VIEW A REPORT” on the Web page 310 or “SEE SURVEY RESULTS” on the Web page 700.

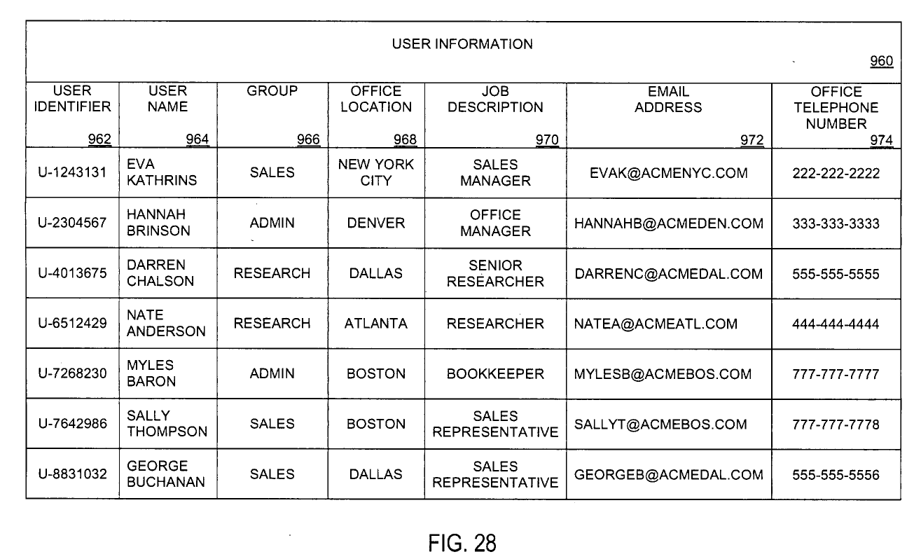

As previously discussed above, in some embodiments a server, user device, or other device may include or access a user database for storing or keeping information regarding one or more invitees, approvers, survey creators, or other users. A representative user information database 960 is illustrated in FIG. 28.

The user information database 960 may include a user identifier field 962 that may include codes or other identifiers for one or more users, a user name field 964 that may include name or other descriptive information for the users identified in the field 962, a group field 966 that may include information regarding one or more groups associated with the users identified in the field 962, an office location field 968 that may include information regarding the office locations for the users identified in the field 962, a job description field 970 that may include information regarding the employment or position of the users identified in the field 962, an email address field 972 that may include email addresses or other contact information for the users identified in the field 962, and a telephone number field 974 that may include telephone or other contact information for the users identified in the field 962.

Other or different fields also may be used in the user information database 960. For example, in some embodiments a user information database may include age, gender, employment history, education, department, marital status or other demographic or personal information for one or more users, etc.

As illustrated by the user information database 960 of FIG. 28, the user identified as “U-7642986” in the field 962 is named “SALLY THOMPSON”, associated with the “SALES” group, is a “SALES REPRESENTATIVE”, and is located in the Boston office. The user “U-7642986” can be contacted via email at “SALLYT@ACMEBOS.COM” or via telephone at “777-777-7778”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A system, comprising:
a first application adapted to receive data indicative of a survey and to receive data indicative of an invitee associated with said survey;
a second application adapted to store information regarding contact information for at least one person; and
wherein said first application further is adapted to retrieve contact information associated with said invitee stored by said second application and to provide, using said contact information, an invitation to said invitee to take said survey.

2. The system of claim 1, wherein said first application is adapted to receive data indicative of an approver associated with said survey, retrieve contact information associated with said approver stored by said second application, and provide an message to said approver information regarding said survey.

3. The system of claim 1, wherein said first application is adapted to provide a reminder to said invitee to take said survey if a response from said invitee is not received.

4. The system of claim 1, wherein said first application is adapted to receive data indicative of a response to said survey and to store at least some of said data indicative of said response in a table along with data regarding said survey.

5. The system of claim 4, further comprising:
a third application adapted to access at least some of said data indicative of a response.

6. The system of claim 5, wherein said first application is adapted to receive data indicative of permission for said third application to access said data indicative of a response.

7. The system of claim 1, wherein said first application is adapted to receive data indicative of a person permitted to access at least a portion of said data indicative of a response.

8. The system of claim 1, wherein said first application is adapted to provide access to said survey to multiple invitees and to store data received from said multiple invitees regarding said survey in the same database table.

9. The system of claim 1, wherein said first application is adapted to provide an interface, said interface adapted to facilitate at least one of the following:
creating said survey;
cloning of a previously created survey;
viewing results associated with said survey; and
sending a reminder to said invitee.

10. The system of claim 1, wherein said first application operates independently of said second application.

11. The system of claim 1, wherein said first application is adapted to provide a preview of said survey.

12. The system of claim 1, wherein said first application is adapted to facilitate creation of said survey.

13. The system of claim 1, wherein said first application is adapted to receive data indicative of a launch date for said survey and to provide said invitation on said launch date.

14. The system of claim 1, wherein said first application is adapted to receive data indicative of an end date for said survey and to prevent access to said survey by said invitee after said launch date.

15. The system of claim 1, wherein said first application is adapted to receive data indicative of how said survey is to be deployed.

16. The system of claim 1, wherein said first application is adapted to receive data indicative of said invitee's response to said survey.

17. The system of claim 16, wherein said first application is adapted to receive data indicative of said invitee.

18. The system of claim 1, wherein said first application is adapted to receive data indicative of whether said invitee's response to said survey is to be associated with said invitee.

19. The system of claim 1, wherein said first application is adapted to receive data indicative of said invitee's response to said survey and to provide a communication to a designated recipient based on said data indicative of said invitee's response.

20. The system of claim 1, wherein said first application is adapted to receive data indicative of said recipient.

21. The system of claim 1, wherein said first application is adapted to allow said invitee to access said survey and provide data indicating that said invitee has chosen not to provide a response to said survey.

22. The system of claim 1, wherein said first application is adapted to provide an interface to facilitate creation of said survey.

23. The system of claim 22, wherein said first application is adapted to determine a role associated with a person accessing said interface.

24. The system of claim 23, wherein said first application is adapted to provide privileges to said person based on said role.

25. The system of claim 1, wherein said first application is adapted to assign a time stamp to said survey.

26. The system of claim 25, wherein said first application is adapted to assign a second time stamp to said survey; provide an invitation to said invitee to retake said survey, and associate results from said invitee for retaking of said survey with said second time stamp.

27. A system for facilitating use of a survey, comprising:
a memory;
a communication port; and
a processor connected to said memory and said communication port, said processor being operative to:
facilitate creation of a survey;
receive data indicative of an invitee associated with said survey;
retrieve data indicative of contact information for said invitee, wherein said data is created by an application outside said system;
provide, using said contact information, an invitation to take said survey to said invitee; and
facilitate access to said survey by said invitee.

28. A method for facilitating use of a survey, comprising:
facilitating creation of a survey;
providing data indicative of said survey to a first application, wherein said first application provides an invitation to take said survey to an invitee; and
facilitating access to said survey by said invitee.

29. The method of claim 28, wherein said first application determines said invitee.

30. The method of claim 28, further comprising:
providing data indicative of said survey to a second application; and
allowing access to results of said survey by said second application.

31. A method for facilitating use of a survey, comprising:
facilitating creation of a survey, said survey having an associated invitee;
retrieving data maintained by an application, said data being indicative of contact information for said invitee;
providing, using said contact information, an invitation to said invitee to take said survey, said invitation including data indicative of a location of said survey; and
facilitating access to said survey by said invitee.

32. The method of claim 31, wherein said facilitating creation of a survey includes receiving data indicative of said invitee.

33. The method of claim 31, wherein said facilitating creation of a survey includes receiving data indicative of a question for said survey.

34. The method of claim 31, wherein said facilitating creation of a survey includes retrieving data indicative of a group of desired invitees of said survey, said invitee being included in said group of invitees.

35. The method of claim 31, wherein said facilitating creation of a survey includes receiving data identifying a previously created survey to be reused.

36. The method of claim 31, wherein said facilitating creation of a survey includes receiving data indicative of a message to be sent if a designated response to said survey is received from said invitee.

37. The method of claim 31, further comprising:
obtaining results to said survey, said results being associated with said invitee.

38. The method of claim 37, further comprising:
storing said results in a database table along with results from at least one other invitee regarding said survey.

39. The method of claim 37, further comprising:
providing access by an application to said results.

40. The method of claim 31, further comprising:
receiving data from said invitee indicative of a response to said survey; and
providing a message to at least one designated person based on said response.

41. The method of claim 31, further comprising:
providing access by an application to said survey.

42. The method of claim 31, further comprising:
receiving data indicative of a party allowed to access results of said survey.

43. The method of claim 31, further comprising:
receiving data indicative of party permitted to receive results of said survey; and
providing said results to said party.

44. The method of claim 31, said data indicative of a location including data indicative of said survey and data indicative of said invitee.

45. The method of claim 31, said data indicative of said location including data indicative of said survey and data indicative of a time stamp associated with said survey.

46. The method of claim 31, further comprising:
providing a reminder to said invitee to take said survey.

47. The method of claim 31, further comprising:
assigning a first time stamp to said survey; and
associating results from said invitee for said survey with said first time stamp.

48. The method of claim 47, further comprising:
assigning a second time stamp to said survey;
providing an invitation to said invitee to retake said survey;
allowing access by said invitee to said survey; and
associating results from said invitee for retaking of said survey with said second time stamp.

49. The method of claim 31, further comprising:
receiving results from said invitee for said survey anonymously.

50. The method of claim 31, further comprising:
tracking that said invitee has provided a response to said survey.

51. The method of claim 50, further comprising:
associating said invitee's response with said invitee.

52. The method of claim 50, further comprising:
maintaining said invitee's response without associating said invitee's response with said invitee.

53. The method of claim 31, further comprising:
receiving data indicative of said invitee.

54. The method of claim 31, further comprising:
receiving data indicating that said invitee has chosen not to participate in said survey.

55. The method of claim 31, further comprising:
receiving data indicative of a parameter associated with said invitee.

56. The method of claim 55, further comprising:
including information in said survey based on said parameter.

57. The method of claim 55, further comprising:
including information in said invitation based on said parameter.

58. The method of claim 31, further comprising:
receiving data indicative of how said survey should be deployed.

59. The method of claim 31, wherein said survey has a plurality of associated invitees and wherein said providing an invitation to said invitee to take said survey includes providing an invitation to said invitee that does not indicate any other invitee in said plurality of associated invitees.

60. The method of claim 31, further comprising:
determining a person who can access results of said survey based on a role associated with said person.

61. The method of claim 31, further comprising:
receiving data indicative of a role and a privilege associated with said role regarding said survey.

62. The method of claim 31, further comprising:
determining a person who can create a survey based on a role associated with said person.

63. A method for facilitating use of a survey, comprising:
facilitating creation of a survey, wherein said survey has an associated invitee and an associated approver;
providing data indicative of a request to said approver to review said survey;
providing an invitation to said invitee to take said survey, said invitation including data indicative of a location of said survey; and
allowing access by said invitee to said survey at said location.

64. The method of claim 63, further comprising:
receiving data indicative of an approval of said survey by said approver.

65. A method for facilitating use of a survey, comprising:
facilitating creation of a first survey, said first survey having an associated first invitee;
facilitating creation of a second survey, said second survey having an associated second invitee;
providing an invitation to said first invitee to take said first survey, said invitation including data indicative of a location associated with said first survey;
allowing access by said first invitee to said first survey;
providing an invitation to said second invitee to take said second survey, said invitation including data indicative of a location associated with said second survey;
allowing access by said second invitee to said second survey; and
storing results of said first survey received from said first invitee and results of said second survey received from said second invitee in the same database table.

66. A computer program product in a computer readable medium for facilitating use of a survey, comprising:
first instructions for creating a survey, said survey having an associated invitee;
second instructions for obtaining data maintained by an application, said data being indicative of contact information for said invitee;
third instructions for sending, using said contact information, an invitation to said invitee to take said survey, said invitation including data indicative of a location of said survey; and
fourth instructions for providing access to said survey by said invitee.

67. A computer program product in a computer readable medium for facilitating use of a survey, comprising:
first instructions for creating a first survey, said first survey having an associated first invitee;
second instructions for creating a second survey, said second survey having an associated second invitee;
third instructions for sending an invitation to said first invitee to take said first survey, said invitation including data indicative of a location associated with said first survey;
fourth instructions for providing access by said first invitee to said first survey;
fifth instructions for sending an invitation to said second invitee to take said second survey, said invitation including data indicative of a location associated with said second survey;
sixth instructions for providing access by said second invitee to said second survey; and
seventh instructions for storing results of said first survey received from said first invitee and results of said second survey received from said second invitee in the same database table.
